(19) United States
(12) Patent Application Publication
(10) Pub. No.: US 2015/0304725 A1
(43) Pub. Date: Oct. 22, 2015

(54) NETWORK TERMINAL SYSTEM, DISPLAY DEVICE, TERMINAL DEVICE, INFORMATION PROCESSING METHOD IN DISPLAY DEVICE, AND PROGRAM

(71) Applicant: HITACHI MAXELL, LTD., Ibaraki-shi, Osaka (JP)

(72) Inventor: Tsuguo Itagaki, Ibaraki (JP)

(21) Appl. No.: 14/646,021

(22) PCT Filed: Nov. 26, 2012
(86) PCT No.: PCT/JP2012/080417

§ 371 Date: May 20, 2015

(51) Int. Cl. H04N 21/482; H04N 21/61; H04N 21/45; H04N 21/441

(52) U.S. Cl. CPC H04N 21/482; H04N 21/441; H04N 21/6125; H04N 21/4532

(57) ABSTRACT

A network terminal system enables a display device to be shared by a plurality of users while protecting the privacy of each person. The network terminal system has a display integrally configured with a touch panel and displaying an operation screen. User profile information is generated, and a first transmitting/receiving means transmits selected display device operation information to a selected display device with the user profile information. A second transmitting/receiving means, connected to the terminal device by a network, receives the operation information and the user profile information from the terminal device, and transmits the user profile information to the terminal device. The display device is further provided with a control means for operating the display device on the basis of the operation information and the user profile received from the terminal device.

### TECHNICAL FIELD

The present invention relates to a network terminal system, a display device and a terminal device.

### BACKGROUND ART

For background art of this technical field, Japanese Patent Application Laid-Open No. 2005-173826 (PTL 1) can be given. In this application publication, it is described that the application publication is based upon electronic equipment shared by plural users by using an external storage medium and provides the electronic equipment that securely protects privacy of each joint owner and can use the external storage medium the application of which is different properly, and in the application publication, it is also described that when the external storage medium is inserted into a slot for inserting the external storage medium of the electronic equipment, information required when a network connection function is used such as ISP information and a mail account information of a user is read from the external storage medium and access for the transmission/reception of the network connection function is executed using the read information.

### CITATION LIST

### Patent Literature

PTL 1: Japanese Patent Application Laid-Open No. 2005-173826

### SUMMARY OF INVENTION

### Technical Problem

The PTL 1 has a problem that usability for a user in various environment of use and various situations of use is not enough. For example, in the PTL 1, when the electronic equipment is shared among plural users, it is required that the electronic equipment can be used properly, protecting privacy of each user, however, when there are a part that does not depend upon privacy as in a case that a television program is merely viewed as in a television receiver, for example, and a part that depends upon privacy as in a case that connection to a network is made and a delivered moving picture program is viewed, proper use every user generally makes usability bad.

### Solution to Problem

To solve the above-mentioned problem, configurations described in Claims, for example, have only to be adopted, and the solution to the problem can be achieved by providing a display device which is used in a network terminal system including the display device and a terminal device as described in Claims, for example, and which has a characteristic that the display device is provided with a communication unit that transmits operation screen information for outputting an operation screen for operating the display device to the terminal device and receives operation information including contents of the operation of the display device based upon the operation screen information and user profile information including setting information every user from the terminal device, an output unit that outputs an operation screen created every user on the basis of the received user profile information and a control unit that operates the display device on the basis of the received operation information.

### Advantageous Effects of Invention

According to the present invention, a more usable video view system can be provided.

### BRIEF DESCRIPTION OF DRAWINGS

FIG. 1A is a block diagram showing one example of a system configuration.

FIG. 1B is a block diagram showing one example of the configuration of a television receiver.

FIG. 1C is a block diagram showing one example of the configuration of a wireless terminal.

FIG. 1D is a block diagram showing one example of the configuration of a contents delivery server.

FIG. 2A shows an example of the internal configuration of a storage and a memory of the television receiver.

FIG. 2B shows an example of the internal configuration of a storage and a memory of the wireless terminal.

FIG. 2C shows an example of the internal configuration of a storage and a memory of the contents delivery server.

FIG. 3A shows a data table showing an example of contents of user profile information managed by the wireless terminal.

FIG. 3B shows a data table showing an example of contents of user profile information managed by the wireless terminal.

FIG. 4A shows a data table showing an example of contents of user authentication information managed by the contents delivery server.

FIG. 4B shows a data table showing an example of contents of equipment authentication information managed by the contents delivery server.

FIG. 5 shows one example of an operational sequence according to a first embodiment.

FIG. 6 shows an example of display on a menu screen of the wireless terminal.

FIG. 7 shows an example of display of a connected equipment list display screen of the wireless terminal.

FIG. 8 shows one example of an operational sequence according to the first embodiment.

FIG. 9A shows an example of display of an operation screen of the wireless terminal.

FIG. 9B shows an example of display of an operation screen of the wireless terminal.

FIG. 10 shows an example of display of an App menu screen of the television receiver.

FIG. 11 shows an example of display of a contents list display screen of the television receiver.

FIG. 12 shows an example of display of a content detail display screen of the television receiver.

FIG. 13 shows one example of an operational sequence according to a second embodiment.

FIG. 14 shows an example of display of a message display screen of a wireless terminal.

FIG. 15 shows one example of an operational sequence according to the second embodiment.

FIG. 16 shows one example of an operational sequence according to a third embodiment.

FIG. 17 shows one example of an operational sequence according to the third embodiment.

FIG. 18 shows an example of display of a message display screen of a television receiver.

FIG. 19 shows an example of a menu display screen of the television receiver.

FIG. 20 shows one example of an operational sequence according to a fourth embodiment.

FIG. 21 shows one example of an operational sequence according to a fifth embodiment.

FIG. 22 shows one example of an operational sequence according to a sixth embodiment.

### DESCRIPTION OF EMBODIMENTS

Referring to the drawings, embodiments of the present invention will be described below.

### Example 1

Referring to the drawings, a first embodiment of the present invention will be described below. In this embodiment, a case that service (hereinafter called IPTV service) that delivers contents such as an image, voice and character information via the Internet is utilized is described as an example, however, the present invention is not limited to this embodiment.

The IPTV service is greatly classified into three services of streaming, download and progressive download on the basis of their forms. The streaming provides a user data of contents from a server sequentially delivered from the server to a client and reproduced to be an image, voice and others on the basis of the data received by the client. Therefore, a network having a sufficiently broad band has a characteristic that a user can view contents at substantially real time.

In the download, the client acquires and stores all contents data from the server beforehand, and reproduces the data for a viewer after the completion of the storage. Therefore, when the data is not required to be viewed at real time, a user can view the data many times at desired timing by acquiring and storing all the contents data beforehand and the download has a characteristic that the client can receive the delivered contents even if the client's network does not have a sufficiently broad band. Moreover, the progressive download is located between these two services and a user sequentially views data stored in a terminal before the delivery of all contents is completed. Hereby, the completion of the storage is not necessarily required to be awaited, when a band is not fully broad, time for storage can also be reduced, and a merit that all the contents can be viewed many times at timing desired by the user if only the storage is completed can be provided.

In content delivery service including the IPTV service, a usage fee as value at which a user receives the delivery service is often counted by a service provider. At this time, the user is registered as a normal user beforehand and various information such as a password (may also be bio-information such as a fingerprint), a name and an address is managed using his/her identifier (ID) for a clue.

When pay contents are delivered, it is verified that accounting information in storing or viewing can be recorded and a usage fee can be paid by a separately specified payment method. At a stage of the utilization of the delivery service, an identifier (ID) and a password of registered information are collated with management information and user authentication for enabling the utilization of the service is required to be made. A content viewing portal screen for selecting and retrieving contents to be delivered and for selecting another service for information distribution is often provided to the authenticated normal user.

Moreover, equipment authentication for verifying whether equipment used by a user is recommended by the service provider or not or whether a program which is operated in equipment and which receives the delivery service is recommended or not prior to the delivery service via communication is often made. Hereby, an action including copying, transferring and altering without permission that contravenes an ordinance such as the copyright law and the illegal usage of contents are prevented.

At this time, contents are encrypted using a common key cryptosystem beforehand, and a key for decrypting cipher is sometimes held with the key bound to contents separately received so that only an authenticated normal user can decrypting or so that decryption is possible in only authenticated normal connected equipment and further, so that decrypting is possible in only normal connected equipment whose normal user is authenticated. In addition, a public key and a private key are prepared on the side of connected equipment or the service provider using a public key cryptosystem, the private key is transmitted to the connected equipment in registering a user, and the service provider and the connected equipment may also use the keys for encryption and decryption. In general, these keys for decryption are recorded together with a time limit and a frequency of the reproduction of contents and a condition of reproduction for reproducible user and equipment and others. A key for encryption is called an encryption key and a key for decryption is called a decryption key.

As described above, the service provider of the IPTV service securely provides content delivery service and others to a user by correlating user authentication, equipment authentication and a decryption key in place of a contents/service provider and performs secure accounting. Afterward, the user receives the delivery of desired contents and correctly receives service such as the reproduction of the contents. Further, on the basis of these, the user may be able to hold contents correlated with a reproducible right on the basis of a copyright.

The user reproduces the contents in predetermined equipment using the contents and the decryption key respectively acquired as described above, however, these normally make the same equipment and the same user a premise. In the meantime, when the same user owns plural equipments and wants to reproduce the same contents in another equipment, there is inconvenience that the same contents are accounted again. Therefore, there is service that allows the same user having a reproducible right to reproduce contents in plural equipments in a range of the number of equipments permitted by the service provider.

Further, there is also service that application software is purchased by downloading it like contents and its function is enjoyed by operating the application software on the side of equipment. As for an authenticated normal user, there is also service that allows the same user having a right for enabling download as in the case of contents to download application software into plural equipments in a range of the number of equipments permitted by the service provider.

[System Configuration]

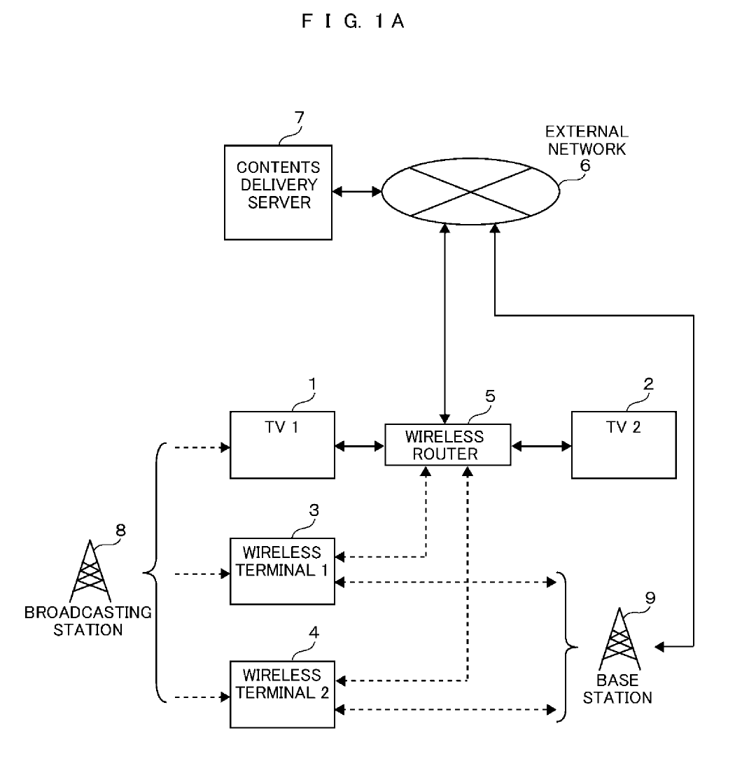

FIG. 1A is a block diagram showing one embodiment of a network terminal system in the first embodiment.

The network terminal system in this embodiment is configured by a television receiver 1, a television receiver 2, a wireless terminal 3, a wireless terminal 4, a wireless router 5, an external network 6 and a contents delivery server 7, for example. The example shown in FIG. 1A is an example when a user of the wireless terminal 3 or the wireless terminal 4 which is a mobile communication terminal such as a mobile phone as an information communication terminal views a television program on the television receiver 1 or the television receiver 2 with the wireless terminal 3 or the wireless terminal 4 together with himself/herself at home and in a shop and others.

The wireless router 5 is provided with a wireless LAN facility such as Wi-Fi and can connect to the external network 6 via a telecommunication line. Moreover, the wireless router 5 is connected to the television receiver 1, the television receiver 2, the wireless terminal (the wireless terminal 1) 3, the wireless terminal (the wireless terminal 2) 4 and the external network 6, and the television receiver 1 or the television receiver 2 and the wireless terminal 3 or the wireless terminal 4 can acquire information from the Internet.

Moreover, the wireless router 5 shall be connected to the television receiver 1 or the television receiver 2 via wired LAN or wireless LAN and shall be connected to the wireless terminal 3 or the wireless terminal 4 via wireless LAN. Here, Wi-Fi means a standard of a wireless local area network (LAN) defined by the standard “IEEE 802.11a/IEEE 802.11b” of Institute of Electrical and Electronics Engineers (IEEE).

The contents delivery server 7 is a contents management device that stores contents such as an image, voice and others and delivers contents in response to a request of the television receiver 1 or the television receiver 2, the wireless terminal 3 or the wireless terminal 4 respectively connected to the network. The contents delivery server 7 is connected to the external network 6, the television receiver 1 or the television receiver 2 and the wireless terminal 3 or the wireless terminal 4 can transmit and receive information to/from the contents delivery server 7 connected to the external network 6 via the wireless router 5 and can receive contents and information related to the contents such as a key for decrypting the encrypted contents. In addition, the wireless terminal 3 or the wireless terminal 4 is connected to a communication network via a base station 9 utilizing a mobile communication network, can also transmit and receive information via the external network connected to the communication network, and can also receive contents.

Referring to the drawings, the first embodiment of the present invention will be described below.

[Hardware Configuration of Television Receiver]

FIG. 1B is one example of a block diagram showing the television receiver 1. As the configuration of each unit of the television receiver 2 is similar to that of the television receiver 1, the description is omitted. The television receiver 1 is connected to an antenna 11, for example, is provided with a tuner/demodulator 12, a channel select controller 13, a signal separator 14, an audio decoder 15, a speaker 16, an audio output unit 17, a video decoder 18, a superimposing unit 19, a display unit 20, a video output unit 21, a communication interface (I/F) 22, input unit 23, a control unit 24, a memory 25 and a storage 26, and each unit is connected via a bus 28.

Various operating functions of the television receiver 1 are realized by an application program. This application program is stored in the storage 26, the control unit 24 transfers the program into the memory 25 from the storage 26, and various functions are realized by the execution of the program by the control unit 24. To simplify the following explanation, it will be described below that various program functional units loaded into the memory 25 mainly realize various functions realized when the control unit 24 executes each program.

The above-mentioned application program may also be stored in the storage 26 beforehand when the television receiver 1 is shipped, is stored in an optical medium such as a compact disk (CD) and a digital versatile disk (DVD) and in a medium such as a semiconductor memory, and may also be installed in the television receiver 1 via a connecting part to the medium not shown. Moreover, the application program is downloaded from the external network 6 via the communication I/F 22 and the wireless router 5 and can also be installed. The various functions by the application program can also be realized by hardware as a processor having the similar functions. When the various functions are realized by the hardware, each unit mainly realizes each function.

The input unit 23 is an input device that accepts operation for input from a user to the television receiver 1 and, for example, the input unit is equivalent to a remote control device, a keyboard and a pointing device such as a mouse.

The control unit 24 receives the operation for input of the user via the input unit 23 and controls the channel select controller 13, the signal separator 14, the superimposing unit 19, the memory 25 (various program functional units), the storage 26, the communication I/F 22 and each unit.

The tuner/demodulator 12 is controlled by the channel select controller 13 and is tuned to a channel of desired service. The tuner/demodulator selects a desired digital broadcast signal which is received via the antenna 11 and which is from a broadcasting station 8, demodulates the broadcast signal, and generates a transport stream.

The channel select controller 13 receives an instruction to select service via the input unit 23 and controls the tuner/demodulator 12 and controls the tuner/demodulator 12 to switch to a channel to be selected. Moreover, the channel select controller 13 controls the tuner/demodulator 12 to switch to service (a channel number) broadcasting an event (a program) currently broadcasted and a broadcast provision unit to which the service belongs according to instructions from various program functional units.

The communication I/F 22 is connected to the wireless router 5 via wired LAN or wireless LAN. The communication I/F 22 transmits/receives various information to/from another television receiver 2, the wireless terminal 3 or the wireless terminal 4 via the wireless router 5. Moreover, the communication I/F 22 can transmit/receive various information to/from a device connected to the external network 6 via the wireless router 5. For example, the communication I/F can 22 receive a content stream (a video/audio stream) from the contents delivery server 7 and others connected to the external network 6 in the form of IP broadcasting and video on demand. Moreover, a video stream and an application program can also be downloaded from the contents delivery server 7 and others connected to the external network 6. The downloaded data or information is stored in the storage 26, for example. In addition, the communication I/F may also directly communicate with external equipment via wireless LAN such as Wi-Fi (a trademark), IrDA (a trademark), Bluetooth (a trademark), Near field communication (NFC) or the others without passing the wireless router 5 in addition to a communication facility with the wireless router 5 or in place of this. Chips according to different communication modes may also be mounted in the communication I/F 22. Further, one chip corresponding to plural communication modes may also be installed in the communication I/F. An example that the communication I/F 22 transmits/receives various information to/from the television receiver 2, the wireless terminal 3 or the wireless terminal 4 via the wireless router 5 will be described below, however, as described above, various information may also be directly transmitted/received without passing the wireless router 5.

The signal separator 14 separates a transport stream acquired in the tuner/demodulator 12 and a stream of contents acquired via the communication I/F 22 every type of video data, audio data, subtitle sentence data, program information and others. Moreover, the signal separator is provided with a function for acquiring program information (for example, program array information (SI)) and transmitting it to another processing block. Moreover, when data transmission request is received from another processing unit, the signal separator transmits specified data to the request source.

The audio decoder 15 decodes audio data separated by the signal separator 14. Audio information decoded by the audio decoder 15 is output from the speaker 16. The audio information decoded by the audio decoder 15 may also be output to external equipment from the audio output unit 17.

The video decoder 18 decodes video data separated by the signal separator 14. The video data decoded by the video decoder 18 is transmitted to the superimposing unit 19.

The superimposing unit 19 superimposes an EPG image and an OSD image respectively created by various program functional units, images and others generated from various information (subtitle information, subtitles, data broadcasting data and others) separated by the signal separator 14 on decoded video information transmitted from the video decoder 18. Moreover, the superimposing unit 19 synthesizes a browser display screen created by a browser engine 2101 described later and a picture signal or selects/switches them. The video information through the superimposing unit 19 is displayed by the display unit 20.

The display unit 20 denotes a display of a television and a personal computer or a liquid crystal panel, for example, and displays broadcasted/delivered video, UI for various operations, a Web browser, images and others stored in the storage 26. Moreover, the video information through the superimposing unit 19 may also be output from the video output unit 21 to external equipment. Displayed images and video may also be images generated by an application program, may also be images and video of contents received via the tuner/demodulator 12, may also be images and video received from the server on the external network 6 via the communication I/F 22, and may also be images and video received from the wireless terminal 3 or the wireless terminal 4 via the communication I/F 22.

Moreover, a digital interface (I/F) 27 that outputs a transport stream of a predetermined program separated by the signal separator 14 without decoding it to be an image and voice may also be provided.

The storage 26 stores an application program and various information created by the application program. Moreover, the storage can store contents such as video/audio streams based upon signals received by the tuner/demodulator 12 and the communication I/F 22. In the memory 25, functional units of the application program stored in the storage 26 are developed under control by the control unit 24.

For images and video displayed on the display unit 20, any image generated by an application program, any image of contents received via the tuner/demodulator 12, any image received from the contents delivery server 7 on the external network 6 via the communication I/F 22 and any image received from the wireless terminal 3 or the wireless terminal 4 via the communication I/F 22 can be displayed on the display unit.

In this embodiment, the example that the television receiver is used is described, however, this embodiment can also be executed by using a recorder without using the display unit and the speaker and providing the similar video and voice to a television receiver, a display unit and a speaker respectively connected to the recorder. Moreover, in this embodiment, the reference numeral 1 denotes the television receiver, however, in place of the television receiver, a set-top box (STB) and a recorder can also be used, and in this case, the speaker 16 and the display unit 20 can also be omitted from the configuration of the television receiver shown in FIG. 1(b).

Moreover, this embodiment can also be executed on a monitor provided with the communication I/F, a large-sized tablet terminal or an electronic white board. Here, the antenna 11, the tuner/demodulator 12, the channel select controller 13 and the signal separator 14 can be omitted from the configuration of the television receiver shown in FIG. 1B.

[Hardware Configuration of Wireless Terminal] FIG. 1C is one example of a block diagram showing the wireless terminal 3. The description of the configuration of each unit of the wireless terminal 4 is omitted because the configuration of the wireless terminal 4 is similar to that of the wireless terminal 3.

The wireless terminal 3 is provided with a tuner/demodulator 31, a signal separator 32, a memory 33, a storage 34, an acceleration sensor 35, a geomagnetic sensor 36, a control unit 37, a display unit 38, a communication interface (I/F) 39, a mobile communication interface (I/F) 40, input unit 41, a GPS receiver 42 and a gyro-sensor 43, for example, and each unit is connected via a bus 44.

The wireless terminal 3 stores an application program in the storage 34, the control unit 37 loads the program from the storage 34 into the memory 33, and the control unit 37 realizes various functions by executing the program. To simplify the following explanation, it will be described below that various program functional units loaded into the memory 33 mainly realize various functions which the control unit 37 realizes by executing each application program.

The application program may also be stored in the storage 34 beforehand when the wireless terminal 3 is shipped, the application program is stored in an optical medium such as a compact disk (CD) and a digital versatile disk (DVD) and in a medium such as a semiconductor memory, and the medium may also be installed in the wireless terminal 3 via a connecting part to the medium not shown. Moreover, an application program is downloaded from the external network 6 via the communication I/F 39 and the wireless router 5 and may also be installed. Otherwise an application program is downloaded from the base station 9 (the delivery source) via the mobile communication I/F 40 and may also be installed. Further, the wireless terminal is connected to a personal computer (PC) that acquires an application program via a network via an interface (I/F) connected to external equipment not shown and the application program can also be installed by transferring it from the PC to the wireless terminal 3 or copying it.

Various functions by the application program can also be realized by hardware as a processor having the similar functions. When various functions are realized by hardware, each processing unit mainly realizes each function.

The tuner/demodulator 12 and the signal separator 14 function as the tuner/demodulator 31 and the signal separator 32 of the television receiver 1 shown in FIG. 1B. As these functions are already described, the description is omitted.

The communication I/F 39 transmits/receives various information to/from the communication I/F 22 of the television receiver 1 via the wireless router 5 using wireless LAN and others. Moreover, the communication I/F 39 is connected to the external network 6 via the wireless router 5 and transmits/receives various information to/from the contents delivery server 7 and others on the external network 6. For example, the communication I/F 39 can receive a content stream (a video/audio stream) from the contents delivery server 7 and others connected to the external network 6 as in the television receiver 1 in the form of IP broadcasting and video on demand. Moreover, a video stream and an application program can also be downloaded from the contents delivery server 7 and others connected to the external network 6. The downloaded data or information is stored in the storage 34, for example. The communication I/F 39 can directly communicate with another equipment such as the television receiver 1 or the television receiver 2 via wireless LAN such as Wi-Fi (the trademark), IrDA (the trademark), Bluetooth (the trademark), NFC or the others without passing the wireless router 5 in addition to a communication facility with the wireless router 5 or in place of this. In the communication I/F 39, chips according to different communication modes may also be mounted. Moreover, one chip that corresponds to plural communication modes may also be mounted. The mobile communication I/F 40 is connected to a communication network via the base station 9 utilizing the third generation mobile communication system (hereinafter called 3G) such as Global system for mobile communications (GSM) (a trademark), Wideband Code Division Multiple Access (W-CDMA), CDMA 2000 and Universal Mobile Telecommunications System (UMTS) or a mobile communication network such as Long Term Evolution (LTE), and can transmit/receive information to/from a server on the communication network.

The control unit 37 receives an operation request from a user via the input unit 41 and controls the signal separator 32, the memory 33 (various program functional units), the display unit 38 and the communication I/F 39. Moreover, the control unit 37 can acquire various information, contents or an application program from the external network 6 via the communication I/F 39 and the wireless router 5 or from a communication network via the mobile communication I/F 40 and the base station 9, and is also provided with a function for passing it to the various program functional units.

The storage 34 stores an application program and various information created by the application program. Moreover, the storage can store contents such as a video/audio stream based upon a signal received from the tuner/demodulator 31, the communication I/F 39 or the mobile communication I/F 40. In the memory 33, functional units of the application program stored in the storage 34 are developed under control by the control unit 37.

The display unit 38 displays images and video stored in the storage 34, video broadcasted and delivered, UI for various operation, a browser and others. For displayed images and video, images generated by an application program, images and video of contents received via the tuner/demodulator 31, images and video received from the contents delivery server 7 on the external network 6 via the communication I/F 39, images and video received from the television receiver 1 via the communication I/F 39, and images and video received from a server on a communication network via the mobile communication I/F 40 can be displayed. Moreover, the display unit 38 may also be integrated with the following touch panel or others.

The input unit 41 is an input device that accepts input operation for the ratio terminal 3 from a user and, for example, physical buttons, a touch panel and others can be used. In this embodiment, an example in which a touch panel is used is described, however, physical buttons may also be used.

Objects and others can be freely moved by operation (dragging) for moving an arbitrary object (icon) on the touch panel with the object touched with a finger or by operation (flicking) for moving an arbitrary object by flicking on the screen by using the touch panel. Moreover, when the object is tapped with a finger once or twice (double taps), the object (the icon) can be activated and the current screen can be switched to another screen. In this embodiment, the above-mentioned each operation on the touch panel is called dragging, flicking and tapping.

The acceleration sensor 35 measures acceleration applied to the wireless terminal 3. The control unit 37 can know which part of the wireless terminal 3 is located on the upside by measuring gravitational acceleration by the acceleration sensor 35, for example and can make the display unit 38 display a screen in accordance with a user's manner of holding the wireless terminal 3 by matching the upside of the screen displayed on the display unit 38 with the upside measured by the acceleration sensor 33. The geomagnetic sensor 36 measures terrestrial magnetism by utilizing plural magnetic sensors.

The GPS receiver 42 receives signals transmitted from plural satellites utilizing a global positioning system (GPS). The control unit 37 can calculate position information of the wireless terminal 3 on the basis of the signals received by the GPS receiver 42. The gyro-sensor 43 measures angular velocity of the wireless terminal 3 caused when a user moves the wireless terminal 3.

[Hardware Configuration of Server]

FIG. 1D is one example of a block diagram showing the contents delivery server 7. The contents delivery server 7 is configured by a communication interface (I/F) 50, a control unit 51, a memory 52 and a storage 53, for example, and each unit is connected via a bus 57.

The contents delivery server 7 stores an application program in the storage 53 and when the control unit 51 reads the program from the storage 53 into the memory 52 and executes the program, various functions can be realized. To simplify the following explanation, various program functional units loaded into the memory 52 shall mainly realize various functions realized when the control unit 51 executes each application program.

The communication I/F 50 is connected to the external network 6, is connected to the wireless router 5 via the external network 6, and transmits/receives various information to/from the communication I/F 22 of the television receiver 1 or the television receiver 2 or the communication I/F 39 of the wireless terminal 3 or the wireless terminal 4. Moreover, the communication I/F 50 can transmit/receive various information to/from the mobile communication I/F 40 of the wireless terminal 3 or the wireless terminal 4 via the base station 9 and a communication network.

The control unit 51 controls the communication I/F 50, the memory 52 (various program functional units) and the storage 53. Moreover, the control unit 51 is also provided with a function for passing contents stored in a contents area 54 of the storage 53 to the television receiver 1 or the television receiver 2 or the wireless terminal 3 or the wireless terminal 4 via the communication I/F 50 and the external network 6 or the base station 9.

The storage 53 stores an application program and various information created by the application program. Moreover, the storage is also provided with a function for storing contents, equipment authentication information, user management information and others. In the memory 52, the functional units of the application program stored in the storage 53 are developed under control by the control unit 51.

[Software Configuration of Television Receiver]

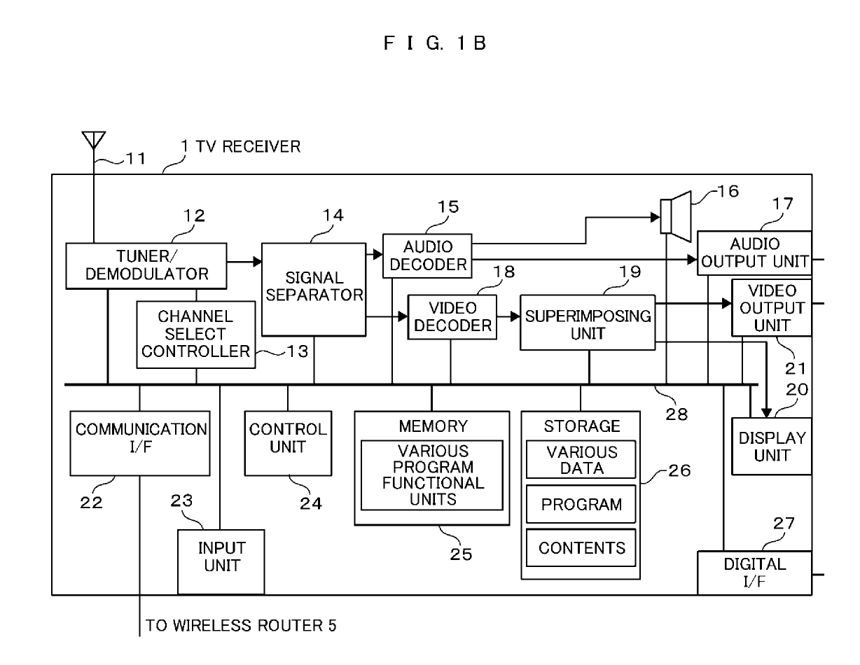

FIG. 2A shows the configuration of the memory 25 and the storage 26 in the configuration of the television receiver 1 or the television receiver 2 shown in FIG. 1B. As shown in FIG. 2A, the storage 26 stores a browser program 2001, a connected equipment authentication program 2006, a content reproduction program 2007, various application programs 2008, an account management program 2009 and a content/application synchronous process program 2010. These programs are loaded into the memory 25 by the control unit 24 and when the control unit 24 executes the programs, functions as a browser engine 2101, a connected equipment authentication unit 2106, a content reproduction unit 2107, the other application unit 2108, an account management unit 2109 and a content/application synchronous process unit 2110 are realized. The browser program 2001, the connected equipment authentication program 2006, the content reproduction program 2007, the various application programs 2008, the account management program 2009 and the content/application synchronous process program 2010 may also be stored in the storage 26 when a product is shipped, and may also be downloaded via the communication I/F 22. The control unit 24 executes these programs and realizes various functions, however, to simplify the following explanation, it will be described below that each functional unit in the memory 25 mainly realizes various functions.

The browser engine 2101 is configured by each functional block of an HTML parser 2102, a database generation unit 2103, a rendering unit 2104 and an image processing unit 2105.

The HTML parser 2102 analyzes logical structure of HTML data acquired via the control unit 24. Moreover, the HTML parser interprets the acquired HTML data and can convert it to internal data used in the television receiver 1.

The database generation unit 2103 generates a database related to its HTML data structure.

The rendering unit 2104 generates layout structure including information of the form of representation determined for each tag on the basis of the database and generates a browser display screen according to data in which size, a position and images are incorporated on the basis of the layout structure.

The image processing unit 2105 converts an acquired image file to image data in the form of a bit map on the basis of image file information such as the location and name of an image file designated by an image tag in the HTML data.

The connected equipment authentication unit 2106 compares authentication information such as user ID and a password respectively acquired from various data in the storage 26 of the television receiver 1 and authentication information transmitted from a connected equipment authentication unit 3106 of the wireless terminal 3 or the wireless terminal 4, and authorizes the connected equipment authentication unit 3106 of the wireless terminal 3 to connect when the equipment authentication information accords. In the meantime, when the authentication information is wrong, the connection of the connected equipment authentication unit 3106 of the wireless terminal 3 is not authorized.

Authentication information stored in a field of various data in the storage 26 of the television receiver 1 is present by input by a user using the input unit 23 or before the television receiver 1 is shipped from a factory. Moreover, a user can verify the authentication information by display on the display unit 20 according to operation by the user or a document attached when the television receiver 1 is purchased. Moreover, a user name and an MAC address of the wireless terminal 3 or the wireless terminal 4 may also be stored in the storage 26 of the television receiver 1 or a nonvolatile memory not shown as the authentication information of connected equipment.

The above-mentioned is one example of an authentication method, and for the authentication method, when the television receiver 1 and the wireless terminal 3 or the wireless terminal 4 are connected via wireless LAN, for example, an authentication/encryption method using a service set identifier (SSID) and a WEP key or WPS key can be used. Well-known technique may also be used for the authentication method and a method of encrypting information transmitted/received when authentication succeeds and in this embodiment, they are not especially limited.

Moreover, when the television receiver receives contents from the contents delivery server 7 by the operation of the wireless terminal and a user views them, the connected equipment authentication unit 2106 has a function for transmitting authentication information stored in the field of various data to a user management unit 4101 of the contents delivery server 7 via the communication I/F 22 and the wireless router 5. Moreover, at this time, equipment authentication information transmitted to the contents delivery server 7 is related to user information in user profile information generated in a user profile generation unit 3109 of the wireless terminal 3 or the wireless terminal 4. In addition, the equipment authentication information can also be separately managed as information which the contents delivery server 7 can recognize.

The content reproduction unit 2107 provides contents to a user by receiving data of the contents (for example, a movie and a drama) delivered from the contents delivery server 7 via the external network 6 and content information and reproducing images, voice and others sequentially received. In this embodiment, a case of the delivery and the reproduction of contents by streaming is described, however, as in an embodiment described later, all data of contents is acquired from the server beforehand and is stored, and after the completion of storage, all the data can also be reproduced for a view. In this case, the content data is stored in a field of contents 2201 of the storage 26.

Moreover, information of a reproduction halt position of contents can be stored in the field of various data in the storage 26 as resumption information and when the reproduction of the same contents by the same user is resumed, reproduction halt position data is acquired from the resumption information and a reproduction initiation position can be acquired. The resumption information is set every user, referring to user profile information acquired from the wireless terminal.

The other application unit 2108 includes an application downloaded from the contents delivery server 7 according to the taste of a user except applications shown in FIG. 2A such as the browser engine 2101 and the content reproduction unit 2107. Each application is activated by tapping an icon for activating an application displayed on the display unit 20 according to the operation of the input unit 23 by a user.

The account management unit 2109 sets the authenticated wireless terminal 3 or 4 as an authenticated user account when the authentication of the wireless terminal 3 or the wireless terminal 4 is completed by the connected equipment authentication unit 2106. Moreover, when user profile information generated in the wireless terminal 3 or the wireless terminal 4 is acquired, the user account and the user profile are registered and managed with them related every user ID on the basis of the user profile information.

Moreover, the account management unit 2109 can accept plural user accounts at the same time and can independently manage them. When concurrent operation is enabled for each user account, the operation is permitted and when concurrent operation is impossible and exclusive operation is required, the user information for the wireless terminal of a user who earlier uses is transmitted to the wireless terminal of a later user so as to take over the right of the usage of the television receiver 1 and so as to inquire residual time.

The content/application synchronous process unit 2110 compares a type of an application downloaded into the wireless terminal 3 or the wireless terminal 4 and an application downloaded into the television receiver 1 or 2, referring to a user profile of each wireless terminal, verifies consistency on the basis of equipment type information described later, and can synchronize applications of the wireless terminal and the television receiver by downloading the corresponding application when a short application exists. Moreover, as for downloaded contents, applications of the wireless terminal and the television receiver can also be synchronized by downloading as described above. Moreover, when an application and contents are downloaded, a message for verification can be displayed on the display unit 20 and it may also be selected via the input unit 23 whether download may be made or not.

[Software Configuration of Wireless Terminal]

FIG. 2B shows the configuration of the memory 33 and the storage 34 in the configuration of the wireless terminal 3 or the ratio terminal 4 shown in FIG. 1C. As shown in FIG. 2B, the storage 34 stores a browser program 3001, an equipment authentication program 3006, a content reproduction program 3007, the other application unit 3008 and a user profile generation unit 3009. These programs are loaded into the memory 33 by the control unit 37 and realize functions as a browser engine 3101, the connected equipment authentication unit 3106, a content reproduction unit 3107, the other application unit 3108 and the user profile generation unit 3109 when the control unit 37 executes the programs. The browser program 3001, the equipment authentication program 3006, the content reproduction program 3007, the other application program 3008 and the user profile generation program 3009 may also be stored in the storage 34 when a product is shipped and may also be downloaded via the communication I/F 39 or the mobile communication I/F 40. The control unit 37 executes these programs and realizes various functions, however, in the following explanation, it will be described that program functional units in the memory 33 mainly realize.

The browser engine 3101 is configured by each functional block of an HTML parser 3102, a database generation unit 3103, a rendering unit 3104 and an image processing unit 3105 as in the browser engine 2101 of the television receiver 1. As the description of the HTML parser 3102, the database generation unit 3103, the rendering unit 3104 and the image processing unit 3105 is similar to that of those in the browser engine 2101, the detailed description is omitted.

The connected equipment authentication unit 3106 transmits authentication information of connected equipment stored in a field of various data beforehand by input by a user using the input unit 41 to the connected equipment authentication unit 2106 of the television receiver 1 via the communication I/F 39 and the wireless router 5 so as to be authenticated by the television receiver 1. Moreover, when authentication is made twice or later, the input of authentication information can also be omitted by referring to authentication information of connected equipment stored in the field of various data in the storage 34.

Further, the connected equipment authentication unit 3106 has a function for transmitting authentication information stored in the field of various data to the user management unit 4101 described later of the contents delivery server 7 via the communication I/F 39 or the mobile communication I/F 40 as authentication information of a destination to which contents are delivered. Furthermore, authentication information can also be managed separately from user profile information which is related to user information in user profile information generated by the user profile generation unit 3109 and which is information that can be recognized by the contents delivery server 7.

The content reproduction unit 3107 provides to a user after the content reproduction unit receives data of contents (for example, a movie and a drama) delivered from the content server 7 and others via the external network 6 or the mobile communication I/F 40 and content information and reproduces images, voice and others sequentially received. In this embodiment, the case of the delivery and reproduction of contents by streaming is described, however, as in an embodiment described later, data of contents are all acquired and stored from the server beforehand, and can also be reproduced for a view after the storage is completed. In this case, the content data is stored in a field of contents 3201 in the storage 34.

Moreover, information of a reproduction halt position of contents can be stored as resumption information in the field of various data in the storage 34 and when the reproduction of the same contents is resumed, position data related to the reproduction halt position is acquired from the resumption information and a position in which the reproduction is to be initiated is acquired. The resumption information can also be stored as user profile information.

The other application unit 3108 includes an application downloaded from the contents delivery server 7 according to the taste of a user except applications shown in FIG. 2B such as the browser engine 3101 and the content reproduction unit 3107. Each application is activated by operation of a user via the input unit 41 by tapping an icon for activating the application displayed on the display unit 20.

The user profile generation unit 3109 has a function for generating user authentication information for being authorized by connected equipment, information set according the taste of a user such as a menu and further, information of a tile and others of an application installed in purchase or acquired by downloading by purchase as user profile information. Information of a set state changed by a user and a newly purchased application is updated.

[Software Configuration of Server]

FIG. 2C shows the configuration of the memory 52 and the storage 53 in the configuration of the contents delivery server 7 shown in FIG. 1D. As shown in FIG. 2C, the storage 53 stores a user management program 4001, a contents management program 4002 and a contents delivery program 4003. These programs are loaded into the memory 52 by the control unit 51 and realize functions as the user management unit 4101, a contents management unit 4102 and a content delivery management unit 4103 when the control unit 51 executes the programs. The user management program 4001, the contents management program 4002 and the contents delivery program 4003 can be stored in an external storage beforehand. The control unit 51 realizes various functions according to these programs, however, to simplify the following explanation, it will be described below that each functional unit in the memory 52 mainly realizes each function.

The user management unit 4101 manages user authentication information for authenticating every user, equipment authentication information for authenticating equipment owned by the user and others. The user authentication information and the equipment authentication information are stored in respective fields of user authentication information 56 and equipment authentication information 55 in the storage 53. The user management unit 4101 verifies whether the following user is a normal registered user or not and whether equipment owned by the user is included in equipments permitted by a service provider of the same user or not by acquiring user authentication information such as a user name and a password respectively input by input using the input unit 23 or the input unit 41 by the user of the wireless terminal 3 and the television receiver 1 via the communication I/F 50 and the external network 6 and equipment authentication information of the equipment used by the user and collating the user authentication information with the authentication information stored beforehand of the user. If the user authentication information is not correct or the equipment exceeds the permitted number of equipments, the user management unit has a function for returning error information.

The contents management unit 4102 manages contents or application data and content information configured by information accompanying these or application information. Content ID (a management number) for uniquely identifying contents, a content format, content description information (a category, a title, the cast, contents and others), content data, the size of contents, a device suitable for display, a charge for content delivery service or caused by reproducing and viewing delivered contents, a term of a view and others are recorded in content information of animation and others.

Moreover, application ID (a management number) for uniquely identifying an application, application description information, the size of the application, a device suitable for display, a charge caused by downloading the application and others are recorded in application information.

These various information is recorded using a record medium such as a hard disk and may also be read into the memory managed by the contents management unit 4102. Moreover, the above-mentioned information may also be managed in a state in which the above-mentioned information is divided as contents or application data and contents or data (metadata) that describes application data. Key information for decrypting and reproducing contents encrypted using RSA cryptography and others so as to protect from a malicious third party on a channel such as the Internet may also be managed. These various information is recorded using a record medium such as a hard disk and may also be read into the memory managed by the contents management unit 4102.

The content delivery unit 4103 can control the delivery of contents such as animation based upon a request for delivery from equipment such as the wireless terminal 3 and the television receiver 1 via the communication I/F 50 and the external network 6 and stored in a field of contents 54 in the storage 53 in accordance with display performance of the connected equipment. In this embodiment, contents having the same contents and different in resolution are stored in the field of contents 54 and contents matched with display performance is delivered according to equipment authentication information in delivery. Only high definition (HD) contents are stored and may also be delivered with the contents suitably down-converted in accordance with display performance in delivery.

[Data Format]

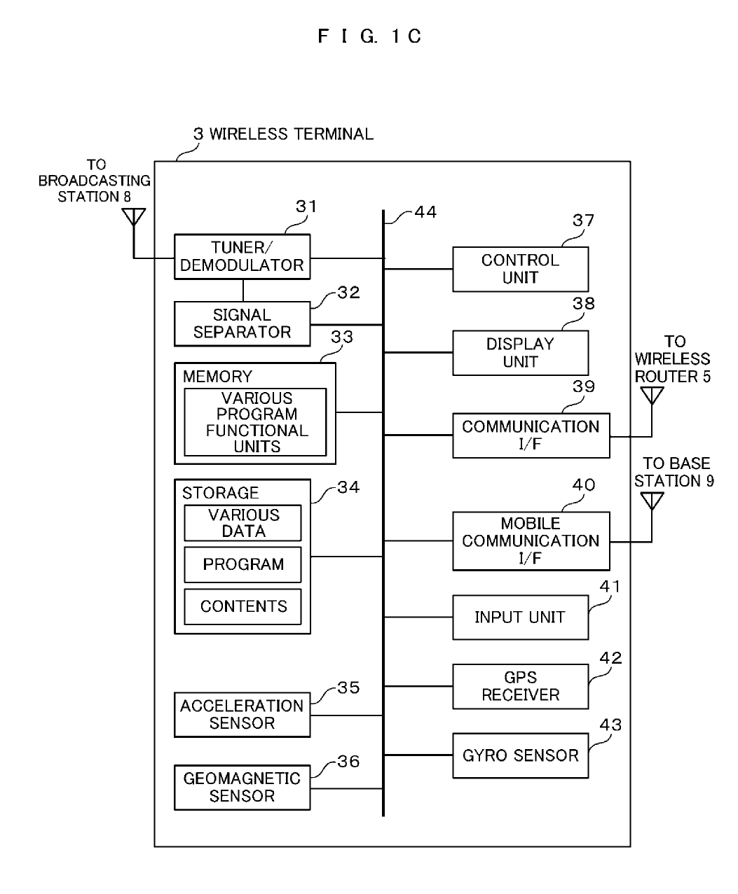

FIGS. 3A and 3B show data tables showing examples of contents of user profile information managed by the user profile generation unit 3109 of the wireless terminal 3 and the wireless terminal 4. As the user profile information, user ID (a management number) 101, a password 102, a unique user name 103, a set parameter 104, an application type 105, download contents 106 and equipment type information 107 are stored.

The user ID 101 and the password 102 are authentication information when contents are delivered from the contents delivery server 7. Moreover, in this embodiment, user profile information includes authentication information, however, because of security and others, authentication information may also be not included in user profile information.

The set parameter 104 includes information set according to the taste of a user such as a menu.

The application type 105 includes a tile of an application installed in purchase and acquired by purchased download.

The equipment type information 107 is information denoting a type of a mobile terminal, a tablet and others, an application such as used OS and convertibility when contents are reproduced, and a user agent (software or hardware used when a user utilizes data on the basis of a certain protocol) may also be utilized. This embodiment is described with user authentication by user ID and a password as a premise, however, user authentication may also be made on the basis of general biometric authentication such as a vein of a finger, a fingerprint, voice, an image of a face and irises, and in that case, items of user authentication information are suitably changed.

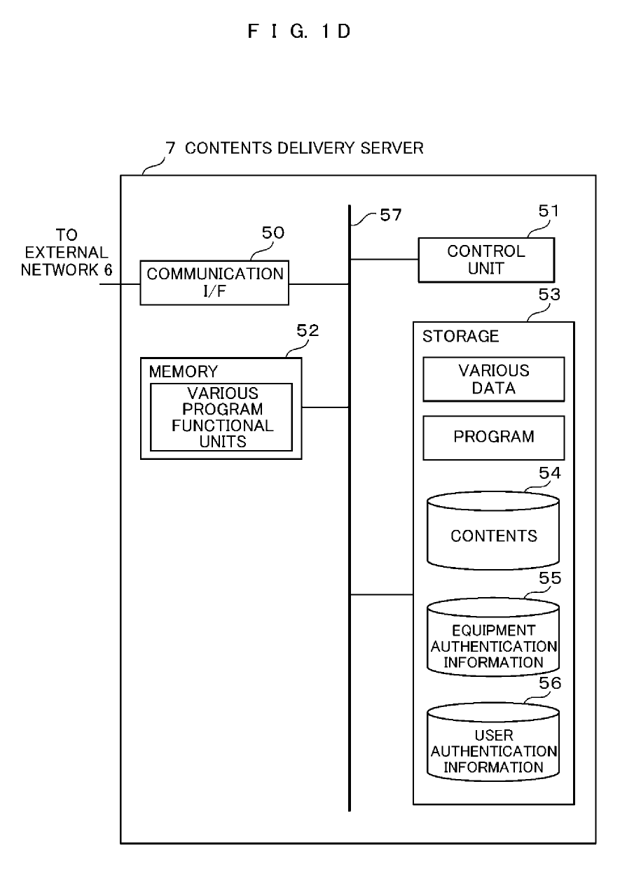

FIG. 4A shows a data table showing an example of contents in the field of user authentication information 56 managed by the user management unit 4101 of the contents delivery server 7. In the field of user authentication information 56 managed by the user management unit 4101, user ID (a management number) 101, a password 102, a unique user name 103, a name, an address, a mail address and others are stored. This embodiment is described with user authentication by a password as the premise, however, user authentication may also be made on the basis of general biometric authentication such as a vein of a finger, a fingerprint, voice, an image of a face and irises, and in that case, items of user authentication information are suitably changed. User authentication information is used for login information when equipment such as the television receiver 1 and the wireless terminal 3 logs in content delivery service.

FIG. 4B shows a data table showing an example of contents in the field of equipment authentication information 55 managed by the user management unit 4101 of the contents delivery server 7. In the field of equipment authentication information 55, user ID (a management number) 101, a password 102, equipment ID 104 showing equipment which a user utilizes, a model name and others are stored, the equipment authentication information is information for uniquely identifying equipment, and a user shall register equipment authentication information with a content delivery service provider beforehand. Moreover, in this embodiment, it is shown that a user whose user ID 101 is “0000101” owns two equipments indicated by the equipment ID 104, and the wireless terminal 3 and the television receiver 1 shall be registered as equipment. A different password from that in user authentication information may also be used for the password 102. Moreover, information proper to equipment such as a media access control (MAC) address can also be used for the equipment ID 104. Further, distinction among types of reproducible contents and resource information of image throughput are related to equipment ID beforehand and can also be stored as a database.

[Operational Sequence]

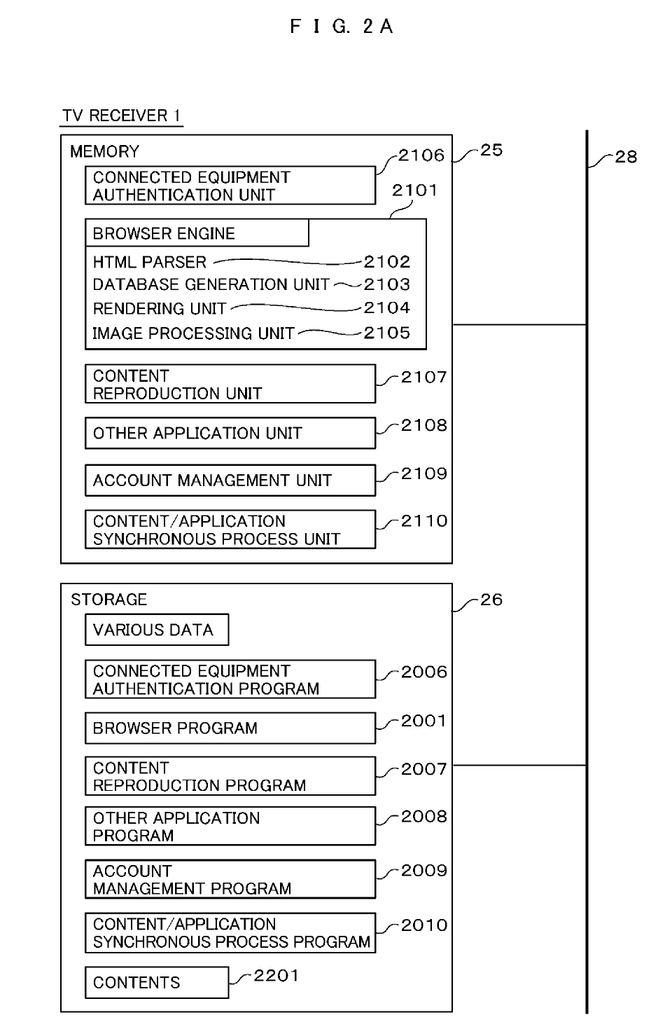

Next, the operation of the system in this embodiment will be described, referring to FIGS. 5 to 12. As for the television receiver 1, there are a case that the television receiver is used using a remote control which belongs to the television receiver 1 in the form of 1 (TV) to 1 (the remote control) and a case that one or plural wireless terminals are used in the form of 1 (TV) to 1 (the wireless terminal) or 1 (TV) to n (wireless terminals). In this embodiment, the case that the form of 1 (TV) to 1 (the wireless terminal) in which the television receiver 1 and one wireless terminal 3 are connected is used will be described. Moreover, the case that the form of 1 (TV) to n (wireless terminals) including plural wireless terminals is used will be described in a second embodiment described later. Moreover, the case that the television receiver is used using the remote control which belongs to the television receiver 1 in the form of 1 (TV) to 1 (the remote control) will be described in a third embodiment described later.

FIG. 5 shows one example of an operational sequence in this embodiment.

In FIG. 5, the wireless terminal 3 is used for an operating terminal and operation until the exchange of content information between the television receiver 1 and the contents delivery server 7 when contents are delivered from the contents delivery server 7 to the television receiver 1 and the contents are displayed on the television receiver 1 is started is shown.

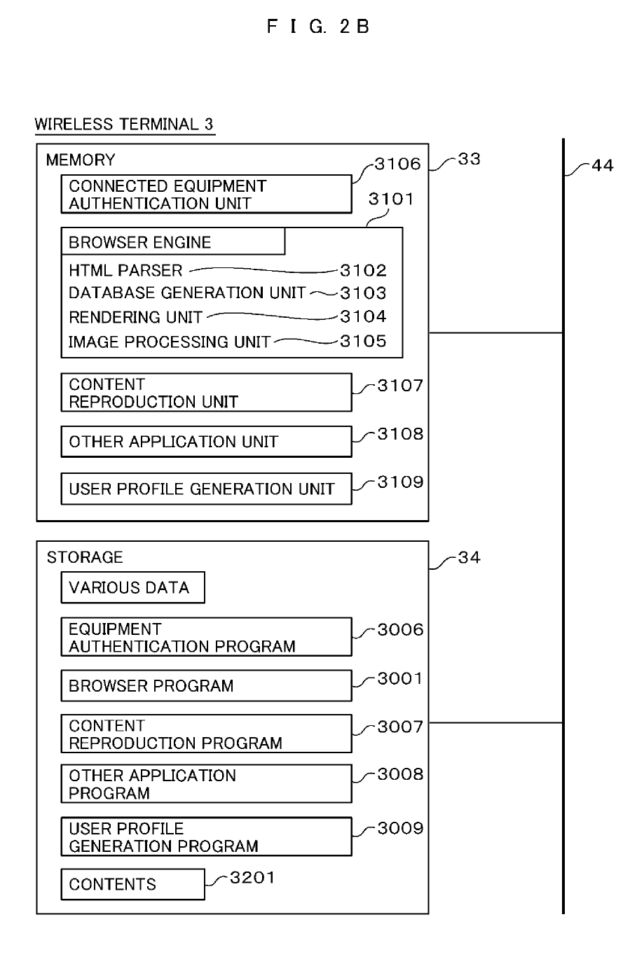

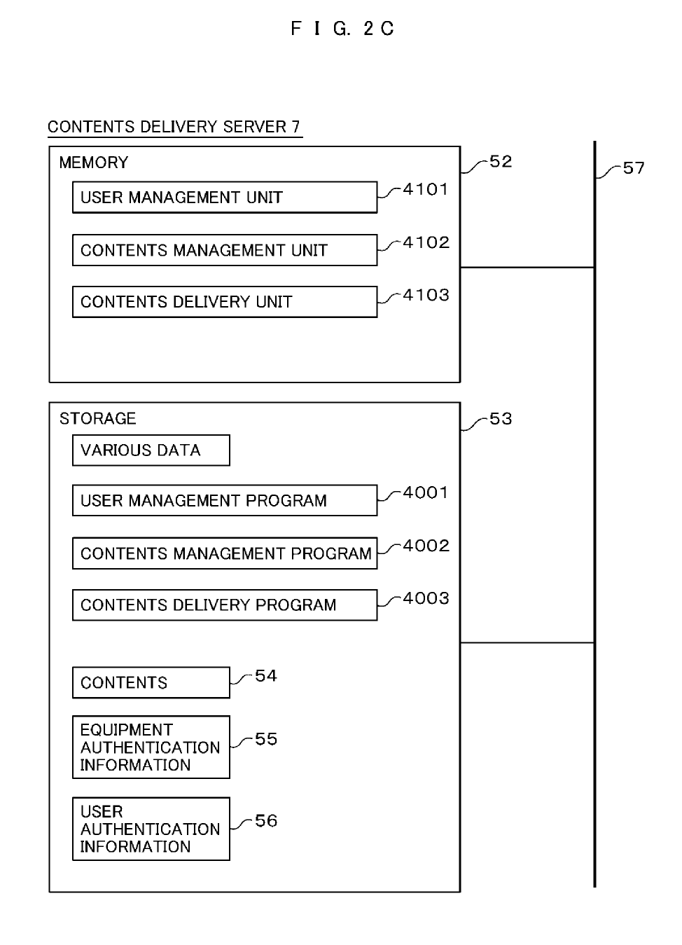

FIG. 6 shows an example of display on a menu screen of the wireless terminal 3. FIG. 7 shows an example of display on connected equipment list display screen of the wireless terminal 3.

As shown in FIG. 5, when “TV operation App” 202 on a menu screen 201 shown in FIG. 6 is tapped, the other application unit 3108 of the wireless terminal 3 receives an instruction to activate an application via the input unit 41 and activates the application in the TV operation App (S101).

When the application in the TV operation App is activated, an equipment list 204 shown in FIG. 7 is displayed on the display unit 38 of the wireless terminal 3 (S102). As shown in FIG. 7, when equipment connected to the network is found, the found equipment is displayed independent of authenticated or unauthenticated and the founded equipment is stored in the storage 34 together with the information of authentication or unauthentication.

In this embodiment, a field displaying TV1 (the television receiver 1) 206, a field displaying TV2 (the television receiver 2) 207 and a field displaying that no television is connected 208 are displayed in the equipment list 204 and the field 206 shows that TV1 is authenticated equipment. The field displaying that no television is connected 208 is an item to be selected when no authentication with equipment is made and contents are used in the wireless terminal itself.

The wireless terminal 3 displays as “authenticated” as shown in FIG. 7 as to equipment already authenticated by the connected equipment authentication unit 2106 out of equipments connected to the network, that is, equipment the equipment ID of which is registered in equipment authentication information and displays as “unauthenticated” as to unauthenticated equipment, that is, equipment the equipment ID of which is not registered. In FIG. 7, the field displaying TV1 (the television receiver 1) 206 shows an example of display on the wireless terminal 3 when the television receiver 1 is already authenticated. Moreover, a check mark 209 is displayed in the field of selected equipment and it can be discriminated which equipment a user selects. Moreover, a button “edit” 205 is a button for deleting connected equipment and adding connected equipment.

When connected equipment is selected via the input unit 41 as shown in FIG. 7, the connected equipment authentication unit 3106 of the wireless terminal 3 transmits connected equipment authentication information registered in the field of various data beforehand to the connected equipment authentication unit 2106 of the television receiver 1 via the communication I/F 39 and the communication I/F 22 so as to receive authentication from the television receiver 1 (S103). In the step S103, a case that the television receiver 1 is selected is described for an example.

When the connected equipment authentication unit 2106 of the television receiver 1 receives connected equipment authentication information from the wireless terminal 3, it compares authentication information stored in the field of various data and the authentication information transmitted from the wireless terminal and checks whether an already authenticated user exists or not when both authentication information accords (S104:YES) (S105). When no authenticated user exists (S105:NO), the connected equipment authentication unit permits the ratio terminal 3 connection (S106). When the authentication of the wireless terminal 3 is completed, the account management unit 2109 sets the wireless terminal 3 as an authenticated user account.

If both authentication information does not accord (S104:NO), the connected equipment authentication unit transmits an error message to the user of the wireless terminal 3. When both authentication information does not accord, a message to persuade the user to input again may also be displayed. Moreover, when the already authenticated user exists (S105:YES), the connected equipment authentication unit transmits a message and can halt the use of the wireless terminal 3 with the previously authenticated wireless terminal preceding the wireless terminal 3.

Here, when no response is made because the television receiver 1 is not powered, for example, a powering command for powering the television receiver 1 in the step S103 is added and the authentication of equipment can also be made again. Equipment that utilizes the television receiver 1 by remote control can be narrowed down by the above-mentioned processing and security can be enhanced. Moreover, in the case of connection to the same equipment as that at the last time, the step S102 can also be omitted by automatically authenticating it.

Next, when the wireless terminal 3 is notified of the permission of connection in the step S106, the user profile generation unit 3109 of the wireless terminal 3 generates profile information of a user of the wireless terminal 3 (S107) and transmits the profile information to the television receiver 1 (S108). The television receiver 1 relates the received profile information to an account of the authenticated user in the step S104 and stores it in the field of various data in the storage 26 as user profile information of the wireless terminal 3 (S109).

Next, a case that the connection of the wireless terminal 3 and the television receiver 1 is finished after the television receiver 1 is operated by the wireless terminal 3 will be described. When a termination button (not shown) displayed on the display unit 38 of the wireless terminal 3 is tapped, operation information (the termination of equipment connection) is transmitted to the television receiver 1 (S110). The television receiver 1 erases the user profile information acquired from the wireless terminal 3 (S111), transmits a response to the termination of equipment connection (logout) to the wireless terminal 3, and makes logout (S112).

In this case, the user profile information includes authentication information such as the user ID 101 and the password 102, the set parameter information 104 such as a menu, a chosen application 105, chosen contents 106 and information such as the equipment type information 107 as described in relation to FIGS. 3, and a set state and a state of the equipment can be used in the same state as the wireless terminal 3 by independently storing the user profile information corresponding to equipment authentication information of the wireless terminal 3 in the case of continuous use in the television receiver 1. Moreover, when the profile information stored in the step S109 is changed on the way of the operation of the television receiver 1, updated data can also be stored as the latest data. Moreover, updated profile information can also be imported into the wireless terminal 3 before the connection of the equipment is finished in the step S110. The handling of updated data will be described in a fourth embodiment described later.

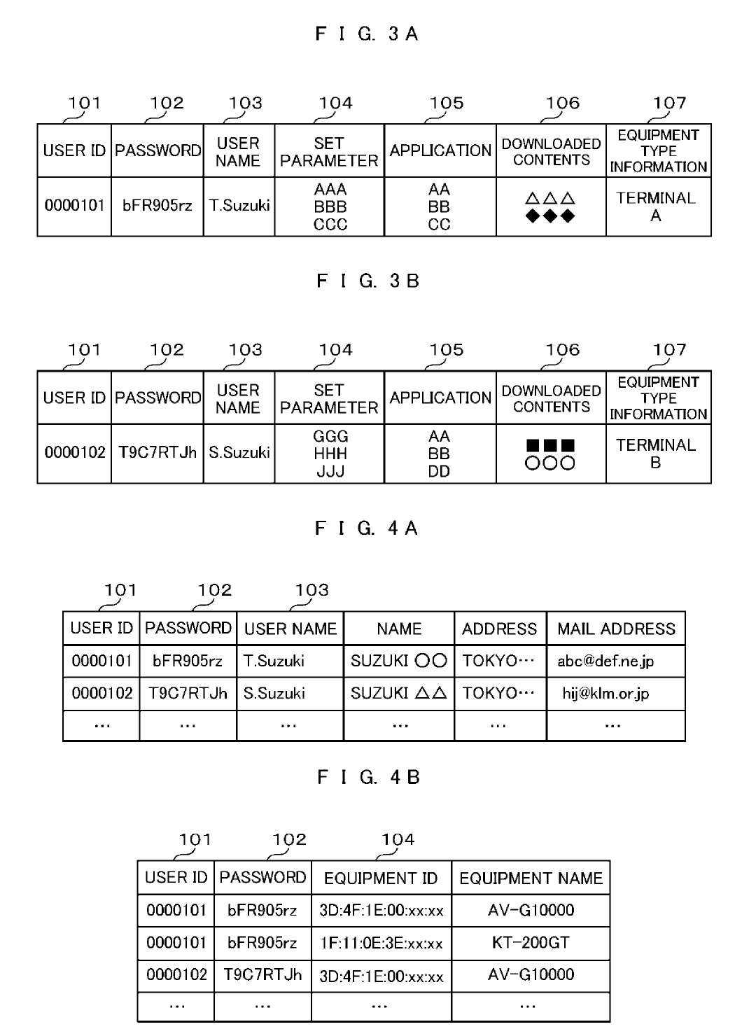

Next, the television receiver 1 and the contents delivery server 7 exchange information of contents and operation when the contents are displayed on the television receiver 1 will be described below, referring to FIG. 8. FIG. 8 shows one example of an operational sequence in this embodiment.

In FIG. 8, steps S201 to S225 are newly added to the sequence (S101 to S109) shown in FIG. 5.

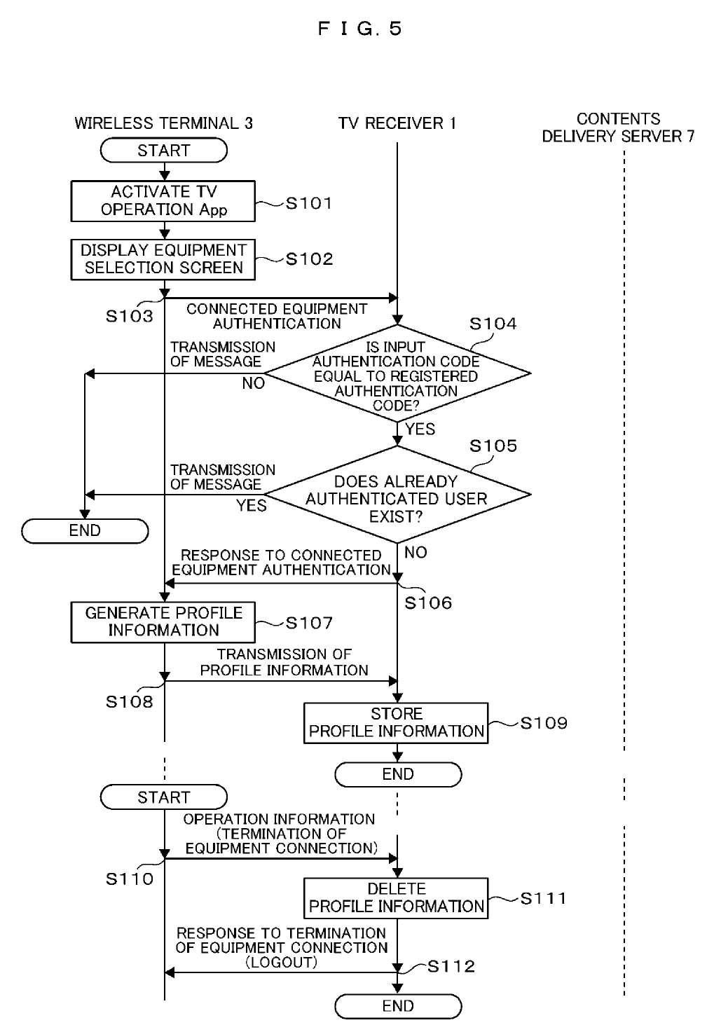

The television receiver 1 transmits operation screen information for displaying an operation screen on the display unit 38 of the wireless terminal 3 to the wireless terminal 3 (S201). The wireless terminal 3 displays the operation screen shown in FIG. 9 on the display unit 38 on the basis of the operation screen information. FIG. 9 show examples of the display of the operation screen of the wireless terminal 3.

In FIGS. 9A and 9B, operating buttons 212, 213 corresponding to connected equipment are displayed on operation screens 210. A connected equipment display 211 displays currently connected equipment. Moreover, when the operation screen 213 is laterally flicked, the operation screen including the operating buttons can be switched to another operation screen. When the operation screen is laterally flicked in FIG. 9A, it can be switched to the operation screen shown in FIG. 9B. Moreover, the operation screen shown in FIG. 9B can be returned to the operation screen shown in FIG. 9A by performing reverse operation. In this embodiment, the two operation screens are provided, however, each equipment can also have one or plural operation screens. Moreover, as for the operation screen, the arrangement of the buttons can also be changed depending upon taste and the arrangement of them can be automatically or manually changed in frequently used order. In addition, a triangular mark 214 is provided to finish the operation screen, when the triangular mark 214 is tapped, the operation screen 210 is closed, and control can be returned to the menu scree shown in FIG. 6.

In this embodiment, operation screen information is acquired from the television receiver 1 in a step S201, however, the acquisition of the operation screen information may also be omitted by installing an application program in the wireless terminal 3 by downloading beforehand.

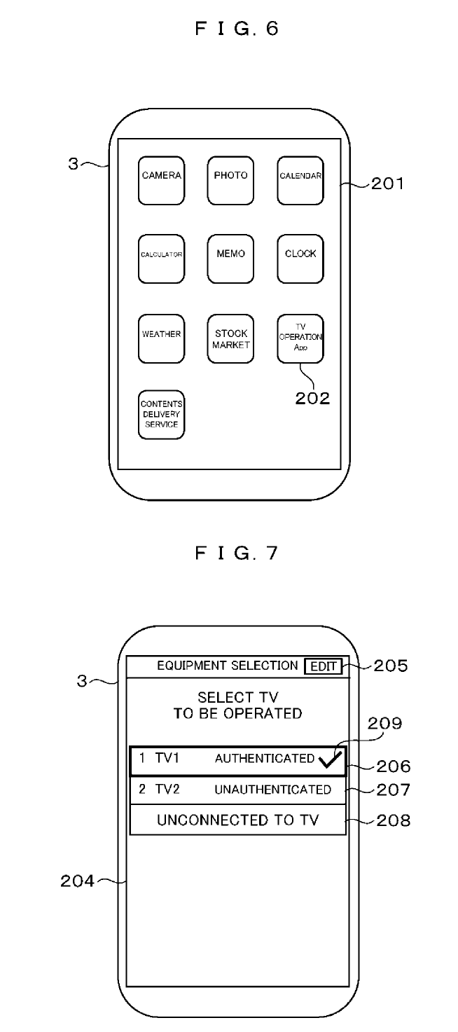

As shown in FIG. 9B, when an App menu button 215 on the operation screen is tapped, the input unit 41 of the wireless terminal 3 transmits operation information (the selection) of the. App menu button 215 to the television receiver 1 (S203). When the control unit 24 of the television receiver 1 receives the operation information (the selection) of the App menu button 215, the control unit instructs the display unit 20 to display an App menu screen 217 shown in FIG. 10 and based upon user setting of the wireless terminal 3, referring to the user profile information stored in the step S109 shown in FIG. 5. FIG. 10 shows an example of display of the App menu screen of the television receiver 1.

When an application shown by an object of an icon for activating the application in an App menu which is not shown and which is based upon the user profile information shown in FIG. 5 does not exist in the App menu of the television receiver 1, the content/application synchronous process unit 2110 can synchronize the application between the wireless terminal 3 and the television receiver 1 by retrieving a coincident application and downloading it from the contents delivery server 7.

Next, when a cursor/determination button 216 of the operation screen 210 of the wireless terminal 3 is tapped, operation information (selection) is transmitted as shown in a step S203, a “CONTENT DELIVERY SERVICE” icon 218 on the App menu screen 217, for example, is selected on the basis of the received operation information (selection) in the television receiver 1 (S204), the other application unit 2108 of the television receiver 1 receives an instruction to activate a browser, and the other application unit activates the browser engine 2101 (S205). The browser engine 2101 accesses to the contents delivery server 7 in a preset content view portal in the wireless terminal 3, referring to the user profile information stored in the step S109 shown in FIG. 5. An address of the content view portal may also be selected from a preset address list in chosen setting, for example, in the field of the set parameter in the user profile information, a last accessed address is stored, and the address may also be accessed.

Next, the browser engine 2101 transmits a request message that requests resources such as Web contents based upon a hypertext transfer protocol (HTTP) to the contents delivery server 7 from the external network 6 via the communication I/F 22 and the wireless router 5. The contents delivery server 7 creates a response message according to the received request message and returns it. The returned response message is input to the browser engine 2101 via the external network 6. In the response message, an HTML document is embedded. The HTML parser 2102, the database generation unit 2103, the rendering unit 2104 and the image processing unit 2105 respectively of the browser engine 2101 generate a browser display screen on the basis of the HTML document with them interlocked and instruct the display unit 20 to display a login screen in the content view portal (S206).

The control unit 24 notifies the browser engine 2101 of login information of the input user name and the input password by the similar operation information to that in the step 203 on the login screen displayed by the above-mentioned processing and transfers a received character string to the contents delivery server 7 as a request message (S207). The contents delivery server 7 authenticates a user, referring to the user authentication information stored in the field of the user authentication information 56 by the user management unit 4101 if the user is a normal registered user (S208).

In this embodiment, the login screen is displayed in a step S206 as an example when selection that no user authentication information is included in user profile information because of security is made, however, an authentication process can also be automatically performed by referring to the user ID and the password in the user profile information stored in the step S109 shown in FIG. 5. Here, the step S206 can be omitted.

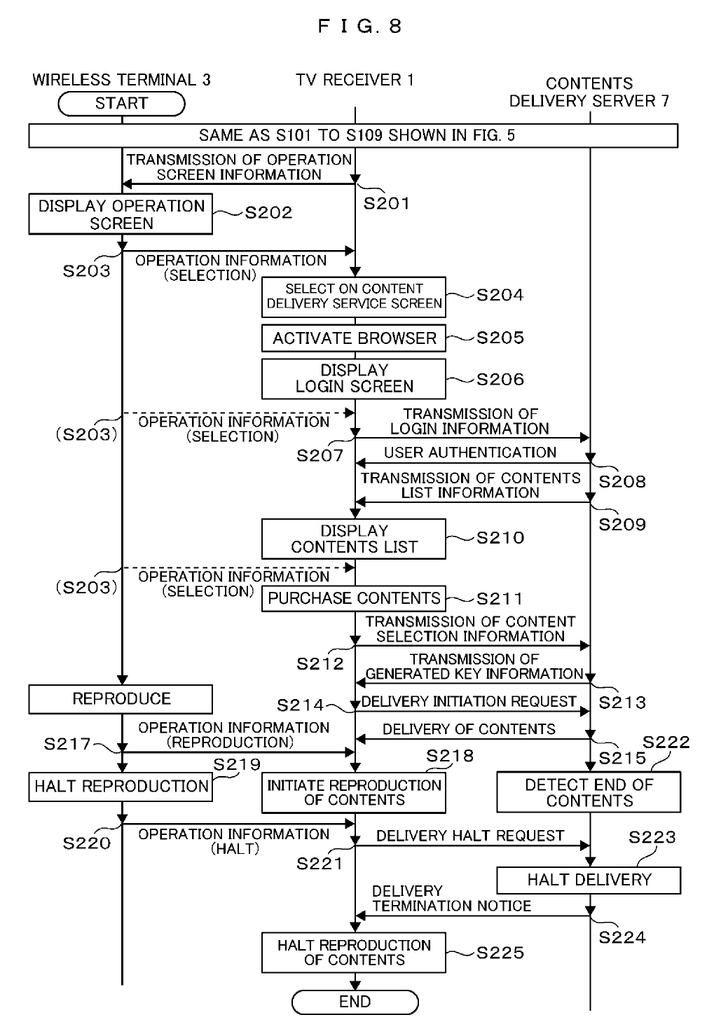

Next, the contents management unit 4102 of the contents delivery server 7 returns the contents list information to the browser engine 2101 as a response message when authentication in S208 is completed (S209). The transmitted contents list information means information for displaying a list of contents managed in the contents management unit 4102 and in the transmitted contents list information, information for identifying managed contents is included. When the browser engine 2101 receives the contents list information from the contents management unit 4102, the browser engine instructs the display unit 20 to display a contents list display screen shown in FIG. 11, referring to content ID, content description information (a category, a title, the cast, contents and others), a charge when the contents are reproduced and viewed and a period of a view respectively included in the contents list information for uniquely identifying contents (S210).

FIG. 11 shows an example of display of the contents list display screen of the television receiver 1.

As shown in FIG. 11, in a field of content title display 219, a content title name, a charge of a view, a period of the view and others are displayed. Moreover, a return button 221 is a button for returning to a high order hierarchy by tapping and can return control to a hierarchy of the previous category by one. An example shown in FIG. 11 shows that Japanese movie 222 in a category of a movie is selected. An end button 223 is an operating unit for instructing to halt a view of contents by tapping.

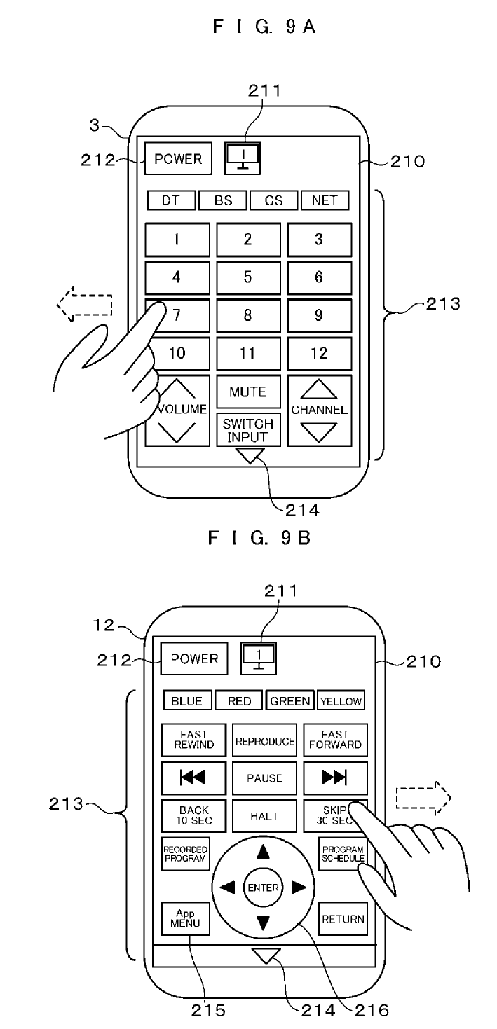

When a title 220 of contents to be viewed is selected on the contents list display screen shown in FIG. 11 according to the operation information of the wireless terminal 3, a content detail display screen shown in FIG. 12 is displayed. FIG. 12 shows an example of display of the content detail display screen of the television receiver 1. As shown in FIG. 12, in a content detailed part 225, a title, the cast, details of contents and others are displayed. A preview button 227 is an operating unit for instructing to display a part of contents so as to view the part of the contents before purchase. An index screen 226 is a static image showing the part of the contents and the part of the contents can be dynamically displayed by selecting the preview 227.

Purchase buttons 228a and 228b are an operating unit for selecting and purchasing contents. In an example shown in FIG. 12, the purchase buttons 228a and 228b related to high definition (HD) image quality and standard definition (SD) image quality are provided so as to select and purchase contents in HD and SD. A return button 229 is an operating unit for returning control to the contents list display screen shown in FIG. 11, that is, for instructing to switch display to the contents list display screen.

When either of the purchase buttons 228a and 228b is selected on the content detail display screen shown in FIG. 12 according to the operation information of the wireless terminal 3 (S211), the control unit 24 transmits content selection information to the contents delivery server 7 (S212). The content selection information includes information for identifying desired contents and information for identifying whether the desired contents can be viewed in the HD image quality or the SD image quality if necessary.

The contents delivery server 7 generates key information for decrypting contents identified on the basis of the content selection information and transmits the key information to the television receiver 1 (S213). The key information includes content ID, an expiration date (or an effective frequency) respectively every content and others in addition to a decryption key for decrypting encrypted content information. The step S213 for the transmission of the key information is required in a case that contents are required to be encrypted and if encryption is not required, the step may also be omitted.

The television receiver 1 transmits a content delivery initiation request when the television receiver receives the key information from the contents delivery server 7 and preparation for the reception of the contents is completed (S214). The content delivery unit 4103 of the contents delivery server 7 that receives the delivery initiation request from the television receiver initiates the delivery of the contents to the television receiver 1 (S215).

When “REPRODUCE” on the operation screen 213 shown in FIG. 9B is tapped by the user via the input unit 41 (S216), the wireless terminal 3 transmits operation information (reproduction) to the television receiver 1 (S217). In the television receiver that receives the operation information (reproduction), the content reproduction unit 2107 executes processing for reproducing the contents. At this time, when a decryption key exists, encrypted content information is decrypted using it and the reproduction of the contents is initiated (S218).

When an operation button for a halt on the operation screen 213 shown in FIG. 9B is selected (S219), the wireless terminal 3 transmits operation information (a halt) to the television receiver 1 (S220) and the television receiver 1 transmits a delivery halt request to the contents delivery server 7 (S221). When the contents delivery server 7 receives the delivery halt request from the television receiver 1 or detects an end of the contents (S222), the contents delivery server halts the delivery of the contents (S223) and transmits content delivery termination notice to the television receiver 1 (S224). When the television receiver 1 receives the content delivery termination notice, it halts the reproduction of the contents (S225).

When the television receiver 1 halts the reproduction in the step S219, the state can also be returned to a state before the initiation of the reproduction of the contents. Moreover, in the case of the halt of reproduction through the step S219, information of a reproduction halt position of the contents is stored in a field of user profile information of the wireless terminal 3 in the storage 26 as resumption information. When operation for reproduction is made via the wireless terminal 3 again and the reproduction of the same contents by the same user is resumed, the content reproduction unit 2107 of the television receiver 1 acquires position data related to the halt of reproduction from the resumption information and can resume reproduction in a resumption initiation position based upon the position data. Moreover, the information of the reproduction halt position of the contents can also be awaited on the side of the contents delivery server 7. Here, the contents delivery server 7 transmits the information of the reproduction halt position of the contents together with the information of the contents in the step S215. Hereby, the television receiver 1 can initiate the delivery from a reproduction initiation position calculated on the basis of the information of the reproduction halt position acquired together with the information of the contents from the contents delivery server 7.

In addition, in this embodiment, the operational flow when contents are delivered from the contents delivery server 7 and are reproduced is described, however, at the timing of the step S215 shown in FIG. 8, content data is all acquired, is stored and the view may also be resumed after the completion of the storage. Here, the processing in the step S222 and the step S223 shown in FIG. 8 is not required. Further, in the step S213 for transmitting the key information, the television receiver 1 can also store the key information received from the contents delivery server 7 in the storage 26, the key information is annulled every time, and every time contents are reproduced, key information can also be acquired from the contents delivery server at the timing of the step 218.

Furthermore, when contents downloaded into the wireless terminal 3 from the contents delivery server 7 are halfway reproduced, the rest is to be reproduced in the television receiver 1 and is to be viewed, the downloaded contents can also be synchronized between the wireless terminal 3 and the television receiver 1 on the basis of user profile information by the content/application synchronous process unit 2110 of the television receiver 1. When the wireless terminal 3 is singly used, the content reproduction unit 3107 executes processing for reproducing the contents like the content reproduction unit 2107 of the television receiver 1.

As described above, the television receiver can be shared among plural users by operating the television receiver using the wireless terminal and can be properly used, protecting the privacy of each user. Moreover, the television receiver can be operated on the television receiver in the same usage environment, taking over usage environment in the wireless terminal.

### Example 2

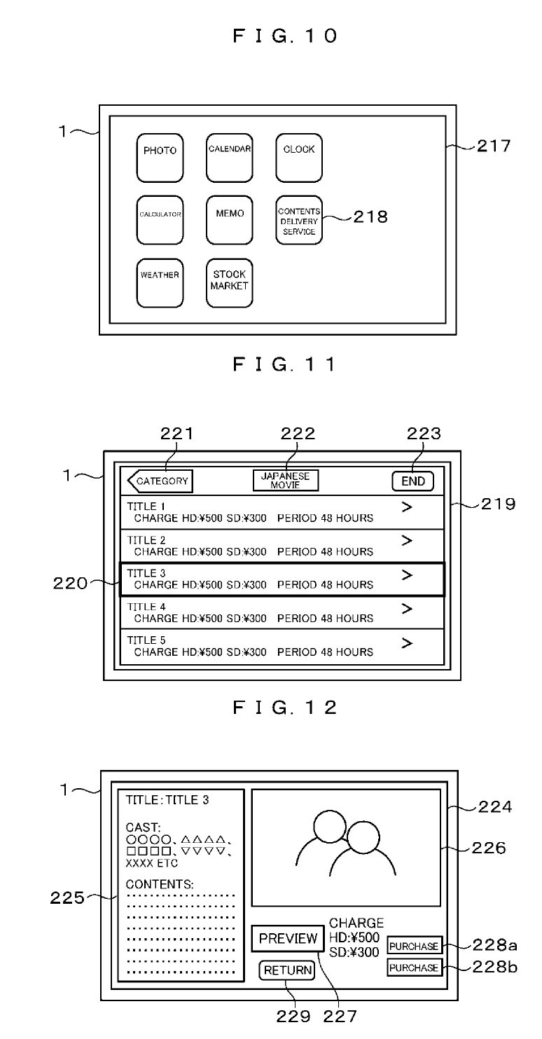

Referring to FIGS. 13, 14 and 15, a second embodiment according to the present invention will be described below.

Moreover, different parts from the first embodiment will be described with the different parts in the center below. As system configuration, software configuration of a television receiver 1 and software configuration of a wireless terminal in the second embodiment are similar to those in the first embodiment, the description is omitted.

[Operational Sequence]

FIG. 13 shows one example of an operational sequence according to the second embodiment. In this embodiment, a case that one television receiver is used among plural wireless terminals in the form of 1 (TV):n (wireless terminals) will be described. FIG. 13 shows the sequence of operation corresponding to the operation shown in FIG. 5 in the first embodiment and shows one embodiment when the wireless terminal 3 is authenticated by the television receiver 1 and the television receiver 1 acquires profile information from the wireless terminal 3. A process (steps S301 to 303) in a limited mode is added to the process shown in FIG. 5 in the first embodiment.

As shown in FIG. 13, TV operation App is activated as in the first embodiment, connected equipment is selected on an equipment connection list display screen, and a request to authenticate the wireless terminal 3 is transmitted to the television receiver 1 (S101 to S103).

When a connected equipment authentication unit 2106 of the television receiver 1 receives equipment authentication information from the wireless terminal 3, it compares authentication information stored in a field of various data and the authentication information transmitted from the wireless terminal 3 and when both authentication information accords (S104:YES), it is next checked whether an already authenticated user exists or not (S105). When no authenticated user exists (S105:NO), the connected equipment authentication unit permits the wireless terminal 3 connection (S106). When the authentication of the wireless terminal 3 is completed, an account management unit 2109 sets the wireless terminal (the wireless terminal 1) 3 as an authenticated user account. When both authentication information does not accord (S104:NO), the account management unit transmits a message to the wireless terminal 3 to notify contents of an error.

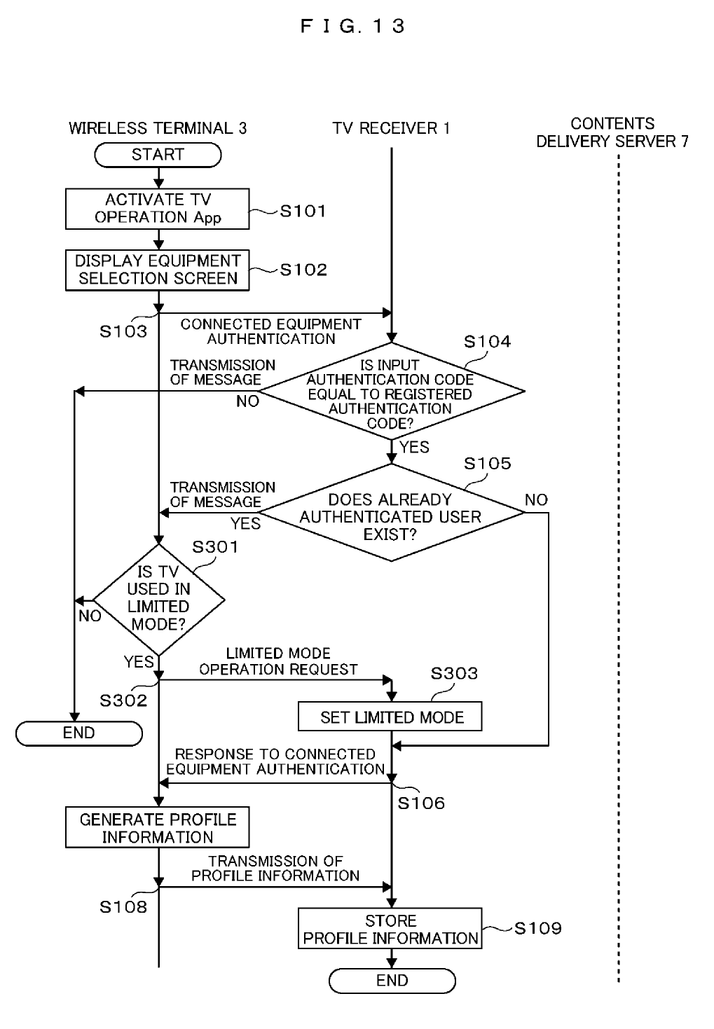

Next, when the already authenticated user exists (S105:YES), a message for inquiring whether the television receiver 1 is to be used in the limited mode or not is transmitted to the wireless terminal 3. FIG. 14 shows an example of display of a message display screen of the wireless terminal 3. As shown in FIG. 14, when “YES” 231 on the message display screen 230 is selected via input unit 41 of the wireless terminal 3 (S301:YES), a limited mode operation request is transmitted to the television receiver 1 (S302). When a control unit 24 of the television receiver 1 receives the limited mode operation request from the wireless terminal 3, the control unit sets the television receiver 1 to the limited mode (S303). When “NO” on the message screen 230 is selected (S301:NO), use by the wireless terminal 3 can be halted at this time.

The limited mode is a mode for enabling limited use of only a function which the already authenticated user and the user that operates in the limited mode can operate in parallel in a case that the already authenticated user does not use the television receiver when the user already authenticated by the television receiver 1 exists. For example, when the already authenticated user is viewing a TV program, functions such as reservation of a view, reservation of recording and the delivery of a recorded program to another equipment can be operated in parallel. At this time, at the timing of YES in the step S301, a list of currently operable functions may also be displayed on a display unit 38 of the wireless terminal 3 of the user that uses later and unavailable functions in operation screen display displayed on the wireless terminal 3 may also be displayed in gray so as to disable selection.

Here, limited function specification information for specifying functions the list of which is displayed or which are displayed in gray is transmitted from the control unit 24 of the television receiver 1 to the wireless terminal 3 via a communication I/F 22 and the wireless terminal 3 that receives the limited function specification information displays the list of the functions specified as described above or displays the unavailable functions in gray. The above-mentioned display can also be realized by storing functions used by the already authenticated users and available functions in the limited mode in a storage 34 of the wireless terminal 3 with both functions correlated, transmitting information for specifying the functions used by the already authenticated users from the television receiver 1 and transmitting operation screen information changed so that only available functions are displayed from the television receiver 1 to the wireless terminal 3.

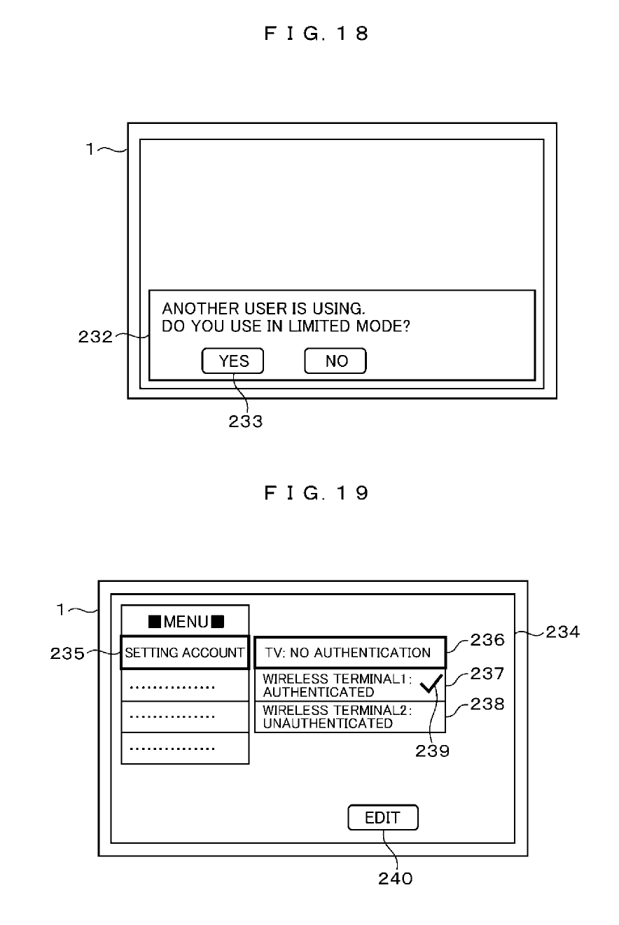

Moreover, in this embodiment, use by the wireless terminal of the already authenticated user is preceded and use in the limited mode is permitted to a user account connected later, however, order of precedence can also be set to a user account by “SETTING ACCOUNT” shown in FIG. 19 beforehand. Here, when the order of precedence of the account connected later is high, the account can be precedently used by forcedly interrupting the wireless terminal having lower precedence.

As the steps S106 to S109 are the same as those in FIG. 5 in the first embodiment, the description is omitted.

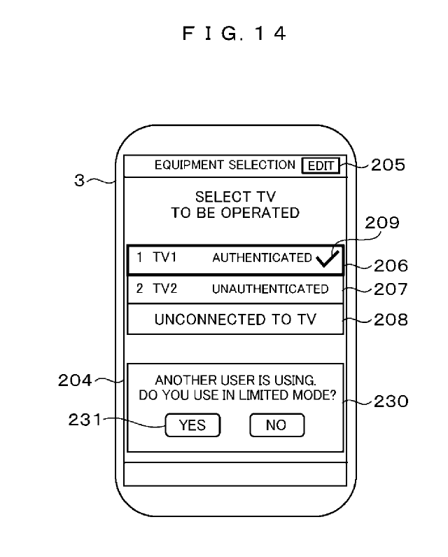

Next, operation when the television receiver 1 and a contents delivery server 7 exchange information of contents and the contents are displayed on the television receiver 1 will be described, referring to FIGS. 15 and 8. FIG. 15 shows one example of an operational sequence according to this embodiment. In FIG. 15, S401 to S404 are newly added to the sequence (S101 to S105, S301 to S303, S106 to S109) shown in FIG. 13.

As shown in FIG. 15, as in the first embodiment, the television receiver 1 transmits operation screen information for displaying an operation screen on the display unit 38 of the wireless terminal 3 to the wireless terminal 3 and a “CONTENT DELIVERY SERVICE” icon is selected in an App menu (S201 to S204).

The account management unit 2109 of the television receiver 1 judges whether simultaneous operation with a function operated by the already authenticated user is possible or not as to the content delivery service because the limited mode is set in the step 303 shown in FIG. 13 and returns control to the processing in the step S205 shown in FIG. 8 if the simultaneous operation is possible (S401:YES). As processing after a step S205 is the similar to that in the sequence shown in FIG. 8, the description is omitted.

When a user of a wireless terminal 4 is the already authenticated user, the account management unit 2109 transmits user information of the wireless terminal 4 (the already authenticated user) to the wireless terminal 3 in a case that simultaneous operation is impossible (S401:NO) in the step 401. Here, in the user information, the user (or a nickname), a mail address and others can be included and they shall be registered with them related to equipment authentication information of the television receiver 1 beforehand.

Next, the wireless terminal 3 generates a mail to the wireless terminal 4 (the already authenticated user) on the basis of the user information received from the television receiver 1 (S402). This mail includes contents of inquiry such as whether use rights of the television receiver 1 can be transferred or not and when the use by the wireless terminal 4 is due to finish if the use rights cannot be transferred. The wireless terminal 3 transmits the mail to the wireless terminal 4 (the already authenticated user) (S403) and receives a response to the mail from the wireless terminal 4 (the already authenticated user)(S404). In this embodiment, in the steps S402 and S403, the mail is automatically generated and transmitted, however, the generation of a mail address on the basis of the user information and the creation of a sentence of the mail are also automated and after the user verifies the contents, the mail may also be transmitted.

As described above, when parallel operation is possible even if the television receiver 1 is used by plural wireless terminals in the form of 1 (TV): n (wireless terminals), the operation is enabled in the usage environment of the wireless terminal. Moreover, when parallel operation is impossible, inquiry of the transfer of use rights, an expiration date for use and others can be automatically transmitted to the wireless terminal of the user already using by mail.

### Example 3

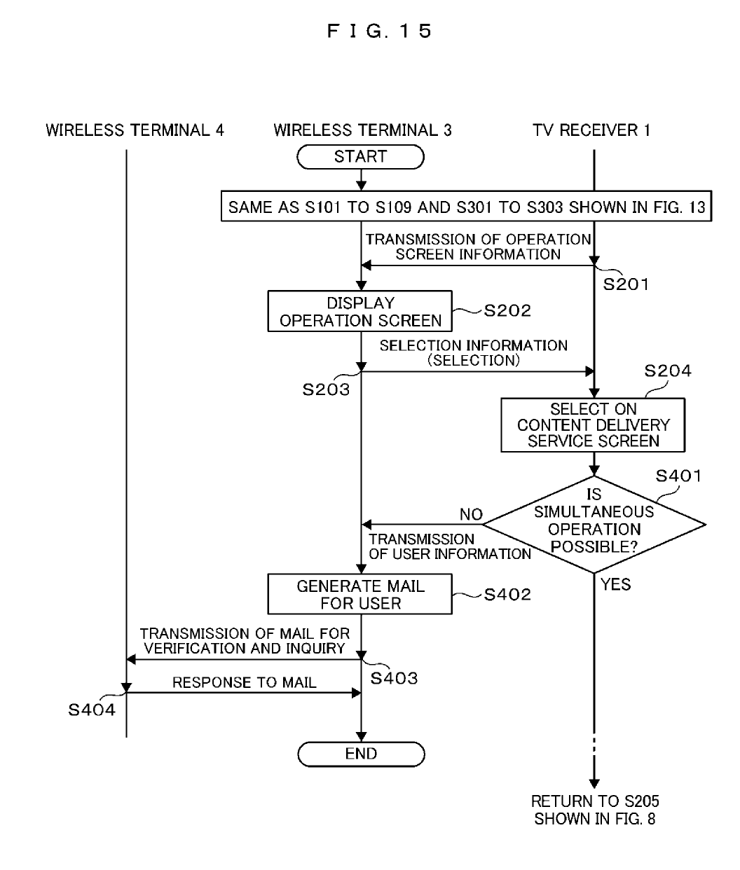

Referring to FIGS. 16, 17, 18 and 19, a third embodiment according to the present invention will be described below.

In this embodiment, a case that a television receiver 1 is used by remote control and others without using a wireless terminal will be described. Moreover, different parts from the second embodiment will be described with the different parts in the center below. As system configuration and software configuration of the television receiver 1 are similar to those in the first embodiment, the description is omitted.

[Operational Sequence]

FIG. 16 shows one example of the operational sequence according to the third embodiment. In this embodiment, a case that the television receiver 1 is used using an attached remote control and others in the form of 1 (TV): 1 (the remote control) will be described. When the television receiver 1 is used without using the wireless terminal, equipment authentication operation is not required.

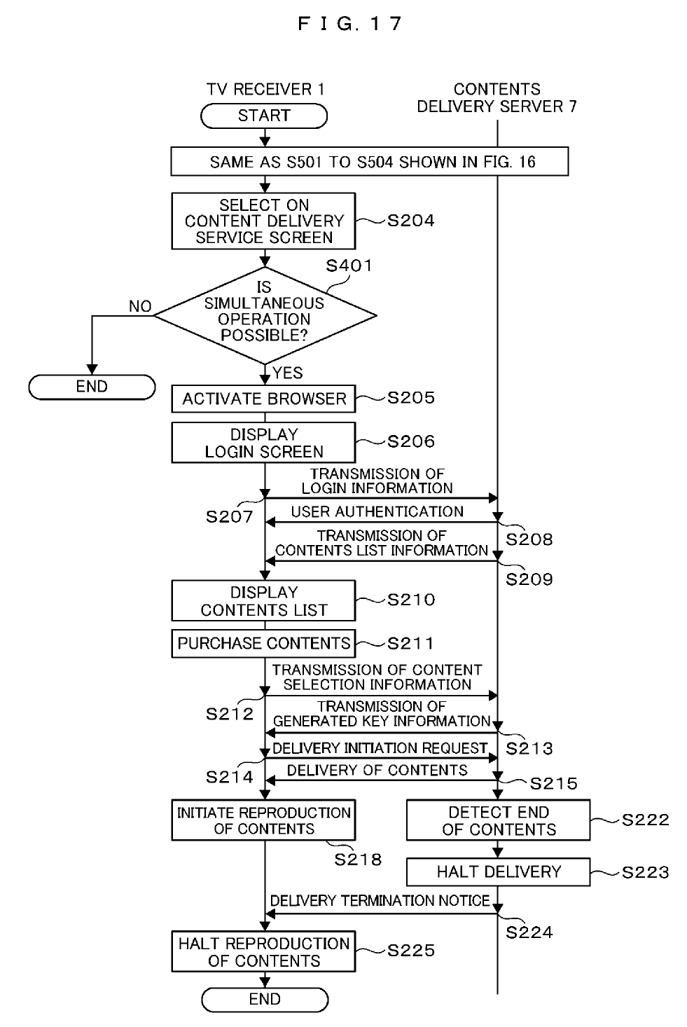

As shown in FIG. 16, when a power source and a channel respectively of the television receiver 1 are operated, a message display screen 232 is displayed as shown in FIG. 18 when a user already authenticated by the television receiver 1 exists (S501:YES). FIG. 18 shows an example of display of the message display screen of the television receiver 1. As shown in FIG. 18, when YES 233 on the message display screen 232 is selected via input unit 23 of the television receiver (S502:YES), an account management unit 2109 of the television receiver sets the television receiver 1 to a limited mode (S503). Next, the account management unit 2109 reads profile information related to an account of the television receiver 1 itself when no account is set as user information.

Here, a state of the authentication of the account of the television receiver 1 can be verified on a menu screen 234 shown in FIG. 19 or the authentication can be set on the screen. FIG. 19 shows an example of the menu display screen of the television receiver 1. As for the television receiver 1, there are a case that the television receiver is singly used using an attached remote control and others and a case that plural wireless terminals are connected and the television receiver is used, and when the television receiver 1 is singly used, the account is set to “NO AUTHENTICATION” in default. In this embodiment, for setting an account 235, display of a television 236, display of a wireless terminal 1 237 and display of a wireless terminal 2 238 are shown, and it is shown that the television is no authentication, the wireless terminal 1 is authenticated and the wireless terminal 2 is unauthenticated equipment. Moreover, though the following change is not shown, the television can also be set as an object of authentication by pressing an “EDIT” button 240.

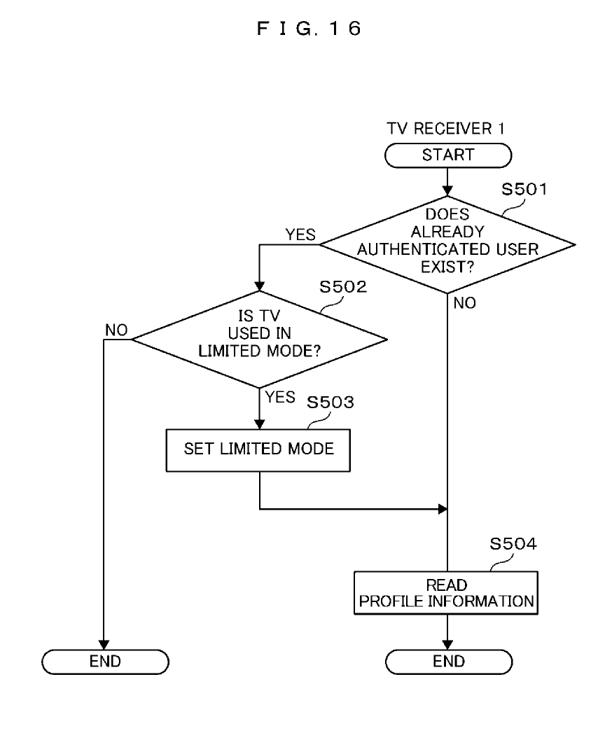

FIG. 17 shows one example of an operational sequence in this embodiment. FIG. 17 shows operation when the television receiver 1 and a contents delivery server 7 exchange content information after the sequence (S501 to S504) shown in FIG. 16 and contents are displayed on the television receiver 1.

When the “CONTENT DELIVERY SERVICE” icon 218 on the App menu screen 217 shown in FIG. 10 is selected via the input unit 23 of the television receiver 1 (S204), the account management unit 2109 of the television receiver 1 judges whether content delivery service can be simultaneously operated with a function operated by the already authenticated user or not because the television receiver is set to the limited mode in the step 503 shown in FIG. 16 and when simultaneous operation is possible (S401:YES), the process shown in FIG. 17 proceeds to processing in a step S205. When simultaneous operation is impossible (S401:NO), the operation of the television receiver 1 can be terminated. As processing after the step S205 is similar to the sequential operation shown in FIG. 8 between the television receiver 1 and the contents delivery server 7, the description is omitted.

As described above, in this embodiment, when the television receiver 1 is used using the remote control attached to the television receiver 1 and others in the form of 1 (TV): 1 (the remote control) without using a wireless terminal, operation for authenticating equipment is not required, a user who owns no wireless terminal can also operate, and operation that does not depend upon privacy can be readily performed.

### Example 4

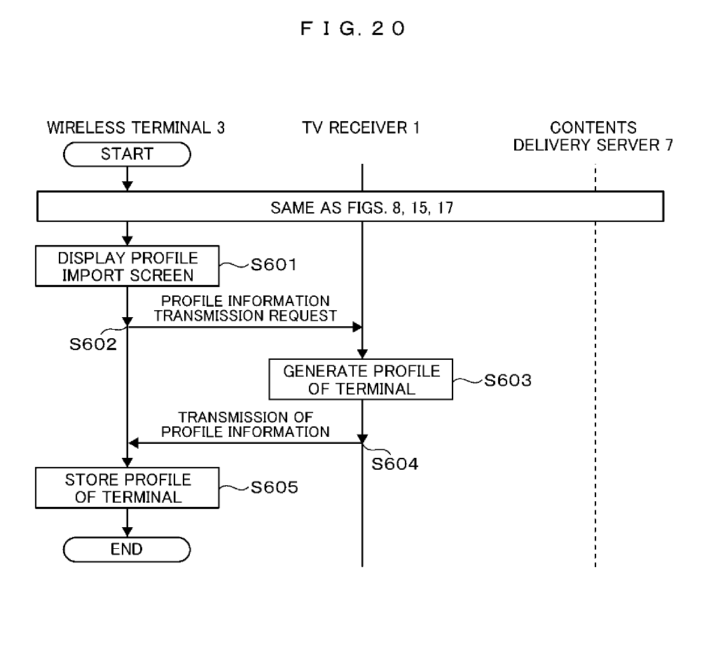

Referring to FIG. 20, a fourth embodiment according to the present invention will be described below.

Moreover, different parts from the first, the second or the third embodiment will be described with the different parts in the center below. As system configuration, software configuration of a television receiver 1 and software configuration of a wireless terminal 3 are similar to those in the first embodiment, the description is omitted.

[Operational Sequence]

FIG. 20 shows one example of an operational sequence according to this embodiment. In this embodiment, profile information updated when the profile information stored in the step S109 shown in FIG. 5 in the first embodiment is changed on the way of operation for the television receiver 1 is stored on the side of a wireless terminal. In FIG. 20, S601 to S605 are newly added.

A profile import screen (not shown) is displayed on a display unit 38 of the wireless terminal 3 by operation by a user whom input unit 41 accepts (S601). When an imported profile is selected via the input unit of the mobile terminal 3, a control unit 37 of the mobile terminal 3 transits a profile information transmission request to the television receiver 1 (S602). When the television receiver 1 receives the profile information transmission request, it generates profile information of the wireless terminal 3 (S603) and transmits the profile information to the wireless terminal 3 (S604). The wireless terminal 3 stores the profile information acquired from the television receiver 1 as profile information of the wireless terminal 3 (S605). A set parameter having no compatibility with the wireless terminal 3 can also be prevented from being reflected on the side of the wireless terminal 3 by filtering and others.

As described above, even if the profile information stored on the side of the television receiver is changed on the way of the operation of the television receiver 1, updated profile information can be stored on the side of the wireless terminal by importing it and the operation can be continued without interrupting the operation in the television receiver 1.

### Example 5

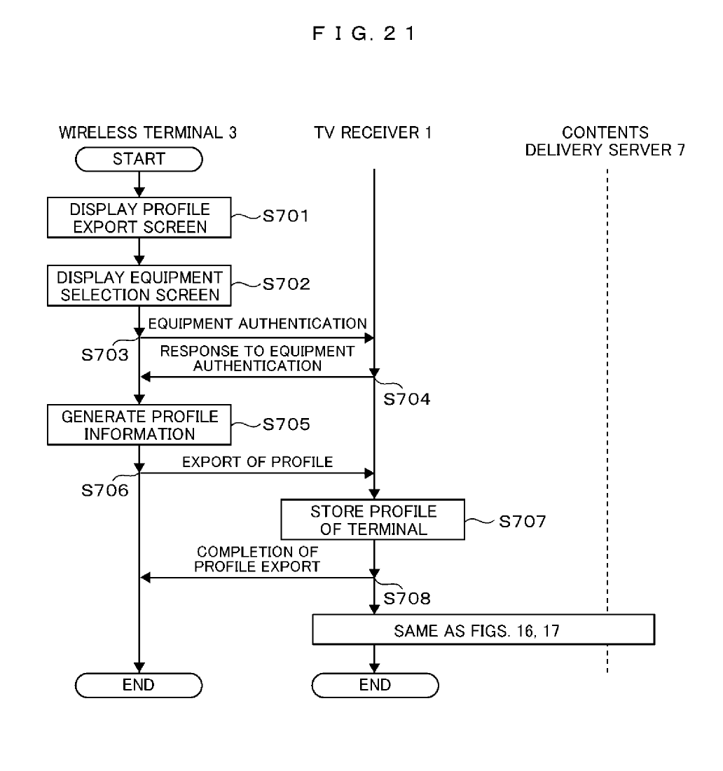

Referring to FIG. 21, a fifth embodiment according to the present invention will be described below.

Moreover, different parts from those in the third embodiment will be described with the different parts in the center. As system configuration, software configuration of a television receiver 1 and software configuration of a wireless terminal 3 are similar to those in the first embodiment, the description is omitted.

[Operational Sequence]

FIG. 21 shows one example of an operational sequence according to this embodiment. In this embodiment, a case that profile information of the wireless terminal 3 is exported to the television receiver 1 beforehand and only the television receiver 1 is used in the similar usage environment to that of the wireless terminal 3 when only the television receiver 1 is used in the third embodiment will be described. FIG. 21 shows steps S701 to S707 newly added before the initiation of the operational flow shown in FIG. 16 or 17 in the third embodiment.

When a profile export screen (not shown) is displayed on a display unit 38 of the wireless terminal 3 by operation by a user whom input unit 41 accepts (S701), a connected equipment list display screen like that shown in FIG. 7 in the first embodiment is displayed (S702). When connected equipment is selected via input unit 41 on the connected equipment list display screen, authentication information is transmitted to the television receiver 1 (S703). When the television receiver 1 receives the authentication information from the wireless terminal 3 and judges that both authentication information accords, the television receiver responds that it authenticates the wireless terminal 3 (S704). The wireless terminal 3 that receives a response of the permission of connection generates profile information (S705) and exports the profile information to the television receiver (S706). The television receiver 1 stores the acquired profile information (S707) and completes the export of the profile information (S708). As the following are the same as the steps shown in FIG. 16 or 17 in the third embodiment, the description is omitted.

As described above, the television receiver 1 can be singly used in the similar usage environment to that of the wireless terminal 3 by exporting the profile information of the wireless terminal 3 beforehand prior to a case that the television receiver 1 is singly used.

### Example 6

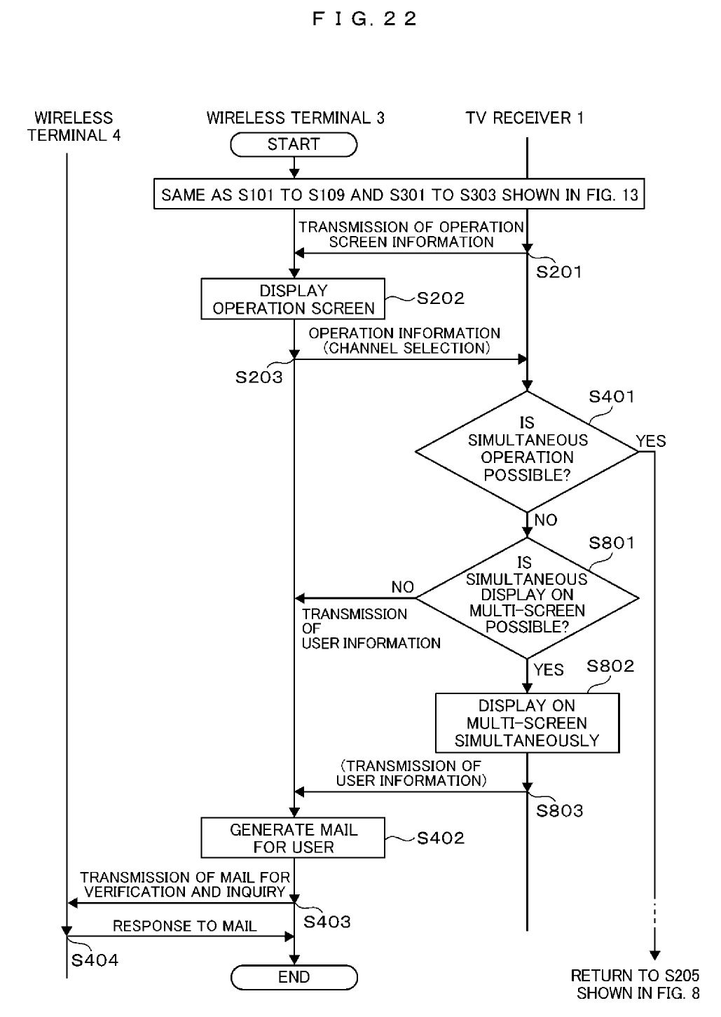

Referring to FIG. 22, a sixth embodiment according to the present invention will be described below.

Especially, different parts from the second embodiment will be described with the different parts in the center below. As system configuration, software configuration of a television receiver 1 and software configuration of a wireless terminal 3 are similar to those in the first embodiment, the description is omitted.

[Operational Sequence]

FIG. 22 shows one example of an operational sequence in this embodiment. In this embodiment, there is described an example of a case that an already authenticated user (a wireless terminal 4) exists in FIG. 15 in the second embodiment, another user operates in a limited mode when the already authenticated user operates in content delivery service and others and the television receiver 1 can simultaneously display programs of plural channels on a multi-screen including two screens and others. Steps S801 to S803 are newly added to FIG. 15 in the second embodiment.

As shown in FIG. 22, the television receiver 1 transmits operation screen information to a wireless terminal 3 (S201) and the operation screen 213 shown in FIG. 9A is displayed on a display unit 38 of the wireless terminal 3 (S202). Next, when a channel button 4 on the operation screen 213 is tapped via input unit 41, for example, operation information (channel selection) is transmitted to the television receiver 1 (S203).

An account management unit 2109 of the television receiver 1 judges whether accepted operation from the wireless terminal 3 can be performed at the same time as an operated function by the already authenticated user or not because the wireless terminal 3 is set to the limited mode in the step S303 shown in FIG. 13 (S401). As the television receiver 1 cannot be simultaneously operated (S401:NO) when the already authenticated user (the wireless terminal 4) exists and a user of the wireless terminal is viewing contents by content delivery service (S401), the account management unit 2109 further judges whether simultaneous display is possible on a multi-screen including two screens and others or not (S801). As a view of a program by operation for selecting a channel and the content delivery service can be simultaneously displayed on the multi-screen including two screens and others (S801:YES), they can be simultaneously displayed on the multi-screen (S802). Moreover, when simultaneous operation is possible in a step S401 (S401:YES), the process proceeds to the processing in the step S205 shown in FIG. 8. As processing after the step S205 is according to the similar sequence shown in FIG. 8, the description is omitted.

Moreover, when simultaneous display is impossible (S801:NO) except the operation for selecting a channel unless the content delivery service is halted once, user information of the wireless terminal 4 (the already authenticated user) is transmitted to the wireless terminal 3. The wireless terminal 3 generates a mail for the wireless terminal 4 (the already authenticated user) on the basis of the user information received from the television receiver 1 (S402). This mail includes inquiry such as whether use rights of the television receiver 1 can be transferred or not or when an expiration date for use is if the use rights cannot be transferred as in the second embodiment. The wireless terminal 3 transmits a mail for the wireless terminal 4 (the already authenticated user)(S403) and receives a response to the mail from the wireless terminal 4 (the already authenticated user)(S404).

In addition, the television receiver 1 can also transmit the user information of the wireless terminal 4 (the already authenticated user) to the wireless terminal 3 in the case of simultaneous display on the multi-screen as in the step 802 (S803). Further, before switch to the multi-screen in the step S802, a message can also be displayed on a display unit 20.

As described above, when the television receiver 1 is used by plural wireless terminals in the form of 1 (TV): n (the wireless terminals), simultaneous display is performed on the multi-screen once in a case that simultaneous display on the multi-screen is possible even if parallel operation is impossible and simultaneously, a mail including inquiry of the transfer of use rights and an expiration date for use can be automatically transmitted to the wireless terminal of an already using user.

The present invention is not limited to the above-mentioned embodiments and various variations are included. For example, the above-mentioned embodiments describe the whole system in detail to intelligibly explain the present invention and the present invention is not necessarily limited to the system provided with the described all configurations. Moreover, a part of the configuration in the certain embodiment can be replaced with the configuration in another embodiment and moreover, the configuration of another embodiment can also be added to the configuration in the certain embodiment. In addition, another configuration can be added, deleted and replaced to/from/with a part of the configuration in each embodiment.

Further, a part or the whole of each configuration, each function, each processing unit and each processing means respectively described above may also be realized by hardware by designing it with an integrated circuit, for example. Furthermore, each configuration and each function respectively described above may also be realized by software by interpreting a program that realizes respective functions and executing them by a processor. Information such as a program that realizes each function, a table and a file can be stored in a storage such as a memory, a hard disk and a solid-state drive and a record medium such as an IC card, an SD card and DVD.

Furthermore, as for the control line and the information line, only lines considered necessary for description are shown, and all control lines and all information lines in a product are not necessarily shown. Actually, it may also be considered that substantially all configurations are mutually connected.

Furthermore, the above-mentioned embodiments have been described using TV1 and TV2 provided with the display unit 20, however, the present invention can also be similarly executed by a set-top box (STB) and a recorder respectively externally provided with a display. Furthermore, the present invention can also be similarly executed by a monitor provided with a communication interface, a large-sized tablet or an electronic white board and others.

### REFERENCE SIGNS LIST

1 Television receiver 1
2 Television receiver 2
3 Wireless terminal 1
4 Wireless terminal 2
5 Wireless router
6 External network
7 Contents delivery server
8 Broadcasting station
9 Base station
12 Tuner/Demodulator
13 Channel select controller
14 Signal separator
15 Audio decoder
16 Speaker
17 Audio output unit
18 Video decoder
19 Superimposing unit
20 Display unit
21 Video output unit
22 Communication interface (I/F)
23 Input unit
24 Control unit
25 Memory
26 Storage
27 Digital interface (I/F)
31 Tuner/Demodulator
32 Signal separator
33 Memory
34 Storage
35 Acceleration sensor
36 Geomagnetic sensor
37 Control unit
38 Display unit
39 Communication interface (I/F)
40 Mobile communication interface (I/F)
41 Input unit
42 GPS receiver
43 Gyro-sensor

1. A display device used in a network terminal system provided with the display device and a terminal device, comprising:
a communication unit that transmits operation screen information for outputting an operation screen for operating the display device to the terminal device and receives operation information including contents of operation of the display device based upon the operation screen information and user profile information including set information every user from the terminal device;
an output unit that outputs an operation screen created every user on the basis of the received user profile information; and
a control unit that operates the display device on the basis of the received operation information.

2. The display device according to claim 1, comprising:
a storage that stores identification information for identifying a user; and
an equipment authentication unit that authenticates the terminal device on the basis of authentication information transmitted from the terminal unit and the identification information, wherein:
the communication unit receives the operation information or the user profile information when the authentication succeeds.

3. The display device according to claim 2, comprising:
a user account management unit that sets a user account on the basis of the authentication information for one or more terminal devices and manages the user account and the user profile information with both related.

4. The display device according to claim 3, wherein:
the control unit instructs the display device to operate in a limited mode in a case that authentication information is transmitted from another terminal device when the terminal device is authenticated; and
the communication unit transmits information for identifying processable operation in parallel with operation based upon the operation information transmitted from the already authenticated terminal device to the another terminal device when the another terminal device is authenticated by the equipment authentication unit.

5. The display device according to claim 3, wherein:
the communication unit transmits information related to the terminal device to another terminal device so as to enable the another terminal device to inquire use of the display device of the terminal device if simultaneous operation for a plurality of user accounts is impossible in a case that authentication information is transmitted from the another terminal device when the terminal device is authenticated.

6. The display device according to claim 3, comprising:
a second input unit that accepts input from a user, wherein:
the user account management unit changes a user account on the basis of the input accepted by the second input unit.

7. The display device according to claim 5, wherein:
the user account management unit can set a user account of the display device; and
the control unit accepts operation for the display device without requiring the input of authentication information by the second input unit when a user account of the display device is not set.

8. A network terminal system provided with a display device and a terminal device, wherein:
the terminal device is provided with:
an output unit that outputs an operation screen on the basis of operation screen information received from the display device;
an input unit that accepts the input of operation from a user on the basis of the operation screen;
a user profile information generation unit that generates user profile information including set information every user; and
a first communication unit that transmits operation information generated on the basis of the input which the input unit accepts and the user profile information to the display device; and
the display device is provided with:
a second communication unit that transmits the operation screen information to the terminal device and receives the operation information and the user profile information from the terminal device;
an output unit that outputs an operation screen created every user on the basis of the received user profile information; and
a control unit that operates the display device on the basis of the received operation information.

9. The network terminal system according to claim 8, wherein:
the terminal device is provided with a first equipment authentication unit that generates authentication information;
the first communication unit transmits the authentication information to the display device;
the display device is provided with:
a storage that stores identification information for identifying a user; and
an equipment authentication unit that authenticates the terminal device on the basis of the authentication information transmitted from the terminal device and the identification information; and
the second communication unit receives the authentication information and receives the operation information or the user profile information when the authentication succeeds.

10. The network terminal system according to claim 8, wherein:
the display device is provided with a user account management unit that sets a user account for one or more terminal devices on the basis of the authentication information and manages the user account and the user profile information with both related.

11. The network terminal system according to claim 10, wherein:
the control unit operates the display device in a limited mode in a case that authentication information is transmitted from another terminal device when the terminal device is authenticated; and
the communication unit transmits information for identifying processable operation to the another terminal device in parallel with operation based upon operation information transmitted from the already authenticated terminal device when the another terminal device is authenticated by the equipment authentication unit.

12. The network terminal system according to claim 10, wherein:
the second communication unit transmits information related to the terminal device to another terminal device so as to enable the another terminal device to inquire of the terminal device use of the display device if simultaneous operation for a plurality of user accounts is impossible in a case that authentication information is transmitted from the another terminal device when the terminal device is authenticated.

13. The network terminal system according to claim 9, wherein:
the display device is provided with a second input unit that accepts input from a user; and
the user account management unit changes a user account on the basis of the input accepted by the second input unit.

14. The network terminal system according to claim 11, wherein:
the user account management unit can set a user account of the display device; and
the control unit accepts operation for the display device without requiring input of authentication information by the second input unit when the user account of the display device is not set.

15. A terminal device used in a network terminal system provided with a display device and the terminal device, comprising:
a communication unit that receives operation screen information for outputting an operation screen for operating the display device from the display device and transmits operation information including contents of operation of the display device based upon the operation screen information and user profile information including set information every user.

16. An information processing method in a display device used in a network terminal system provided with the display device and a terminal device, comprising:
transmitting operation screen information for outputting an operation screen for operating the display device to the terminal device;
receiving operation information including contents of operation of the display device based upon the operation screen information and user profile information including set information every user from the terminal device;
outputting an operation screen created every user on the basis of the received user profile information; and
operating the display device on the basis of the received operation information.

17. A program for performing a process in a display device used in a network terminal system provided with the display device and a terminal device, comprising:
a transmission step for transmitting operation screen information for outputting an operation screen for operating the display device to the terminal device;
an output step for receiving operation information including contents of operation of the display device based upon the operation screen information and user profile information including set information every user from the terminal device and outputting an operation screen created every user on the basis of the received user profile information; and
an operation step for operating the display device on the basis of the received operation information.
